(19) United States
(12) Patent Application Publication
(10) Pub. No.: US 2011/0176060 A1
(43) Pub. Date: Jul. 21, 2011

(54) DATA FEEDBACK FOR BROADCAST APPLICATIONS

(75) Inventors: Chong U. Lee, San Diego, CA (US); Vijayalakshmi R. Raveendran, San Diego, CA (US)

(73) Assignee: Qualcomm Incorporated, San Diego, CA (US)

(21) Appl. No.: 12/715,512

(22) Filed: Mar. 2, 2010

Related U.S. Application Data
(60) Provisional application No. 61/297,100, filed on Jan. 21, 2010.

(51) Int. Cl. H04N 5/38; H04L 27/00; H04B 1/69

(52) U.S. Cl. 348/723; 375/259; 375/130; 375/E01.001; 348/E05.093

(57) ABSTRACT

This disclosure relates to techniques for processing feedback associated with data previously transmitted by a communication device. One example communication system comprises one or more processors, a channel identifier, a transmitter, and a data receiver/feedback unit. The channel identifier is operable to identify at least one channel currently available in a digital broadcast spectrum. The transmitter is operable to transmit data via the at least one identified channel of the digital broadcast spectrum, wherein the transmitted data complies with a digital broadcast format. The data receiver/feedback unit is operable to receive a representation of the data and compare at least a portion of the received representation of the data to at least a portion of the transmitted data. The one or more processors are configured to determine whether to adjust a broadcast transmission parameter or a data transformation parameter for use in subsequent data communication based upon the comparison.

This application claims the benefit of U.S. Provisional Application 61/297,100, filed on Jan. 21, 2010, the entire content of which is incorporated herein by reference.

### TECHNICAL FIELD

This disclosure relates to the wireless transmission of data.

### BACKGROUND

Presently, several solutions for the wireless display of multimedia data, such as wireless HDMI (High-Definition Multimedia Interface), are in development. These solutions are designed to replace the HDMI cable between a particular media source component (e.g., set-top box, digital versatile disc (DVD) player, computing device) and a display device.

Some developers have developed solutions that use proprietary methodologies for the transmission of uncompressed video. Other solutions may target consumer electronic devices (e.g., game consoles or DVD players) and require dedicated hardware on both the host and client side. The level of power consumption for such dedicated devices may be undesirable. In addition, the transmission of uncompressed video may limit expansion capabilities to support higher-resolution data transmission.

### SUMMARY

In general, this disclosure relates to techniques for processing feedback that is associated with data previously transmitted by a communication device. In some examples, techniques described in this disclosure may facilitate the wireless transmission of data for various services/applications from one or more devices (e.g., mobile or handheld devices) to an external device utilizing an identified, available channel of a spectrum, and the subsequent detection of feedback data (e.g., audio data) from the external device. The one or more devices may process the received feedback and, in some cases, adjust a transmission power for subsequent data communication to the external device based upon the received feedback.

In one example, a method comprises identifying at least one channel currently available in a digital broadcast spectrum, transmitting data via the at least one identified channel of the digital broadcast spectrum, wherein the transmitted data complies with a digital broadcast format, and receiving a representation of the data. The method further comprises comparing, by at least one device, at least a portion of the received representation of the data to at least a portion of the transmitted data, and determining, by the at least one device, whether to adjust a broadcast transmission parameter or a data transformation parameter for use in subsequent data communication based upon the comparison.

In one example, a communication system comprises one or more processors, a channel identifier, a transmitter, and a data receiver/feedback unit. The channel identifier is operable by the one or more processors to identify at least one channel currently available in a digital broadcast spectrum. The transmitter is operable by the one or more processors to transmit data via the at least one identified channel of the digital broadcast spectrum, wherein the transmitted data complies with a digital broadcast format. The data receiver/feedback unit is operable by the one or more processors to receive a representation of the data and compare at least a portion of the received representation of the data to at least a portion of the transmitted data. The one or more processors are configured to determine whether to adjust a broadcast transmission parameter or a data transformation parameter for use in subsequent data communication based upon the comparison.

In one example, a computer-readable storage medium is encoded with instructions for causing one or more processors to identify at least one channel currently available in a digital broadcast spectrum, transmit data via the at least one identified channel of the digital broadcast spectrum (where the transmitted data complies with a digital broadcast format), and receive a representation of the data. The computer-readable storage medium is further encoded with instructions for causing the one or more processors to compare at least a portion of the received representation of the data to at least a portion of the transmitted data, and determine whether to adjust a broadcast transmission parameter or a data transformation parameter for use in subsequent data communication based upon the comparison.

The techniques described in this disclosure may be implemented in hardware, software, firmware, or any combination thereof. For example, various techniques may be implemented or executed by one or more processors. As used herein, a processor may refer to a microprocessor, an application specific integrated circuit (ASIC), a field programmable gate array (FPGA), a digital signal processor (DSP), or other equivalent integrated or discrete logic circuitry. Software may be executed by one or more processors. Software comprising instructions to execute the techniques may be initially stored in a computer-readable medium and loaded and executed by a processor.

Accordingly, this disclosure also contemplates computer-readable storage media comprising instructions to cause a processor to perform any of a variety of techniques as described in this disclosure. In some cases, the computer-readable storage medium may form part of a computer program storage product, which may be sold to manufacturers and/or used in a device. The computer program product may include the computer-readable medium, and in some cases, may also include packaging materials.

The details of one or more aspects are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a communication system, including a data receiver/feedback unit, which is communicatively coupled to one or more data receivers via one or more wireless communications.

FIG. 2 is a block diagram illustrating an example of a communication device, including a data receiver/feedback unit, which is communicatively coupled to one or more receivers that are coupled to one or more output devices.

FIG. 3 is a block diagram illustrating an example of a mobile communication device communicatively coupled to a digital television (TV) receiver and a display device/speaker system, which may be included within a digital TV.

FIG. 4 is a conceptual diagram illustrating an example of wireless transmission of display data from a communication device to a digital TV.

FIG. 5 is a block diagram illustrating an example of a communication device that may be used as the communication device shown in any of FIGS. 1-3, or as one of the devices shown in FIG. 4.

FIG. 6 is a block diagram illustrating an example of a transformation unit/transmitter, in conjunction with a channel identifier, sampling unit, and data receiver/feedback unit, which may be implemented within a communication device, such as the communication device shown in FIG. 5.

FIG. 7 is a block diagram illustrating an example of the sampling unit shown in FIG. 6.

FIG. 8 is a block diagram illustrating an example of the data receiver/feedback unit shown in FIG. 6.

FIG. 9 is a conceptual diagram illustrating an example of a transmit data stream and a receive data stream that each include digital watermark information.

FIG. 10 is a flow diagram illustrating an example of a method that may be performed by a device, such as a device included within the system of FIG. 1 or one of the communication devices shown in FIGS. 2-5.

FIG. 11 is a flow diagram illustrating an example of another method that may be performed by a device, such as a device included within the system of FIG. 1 or one of the communication devices shown in FIGS. 2-5.

### DETAILED DESCRIPTION

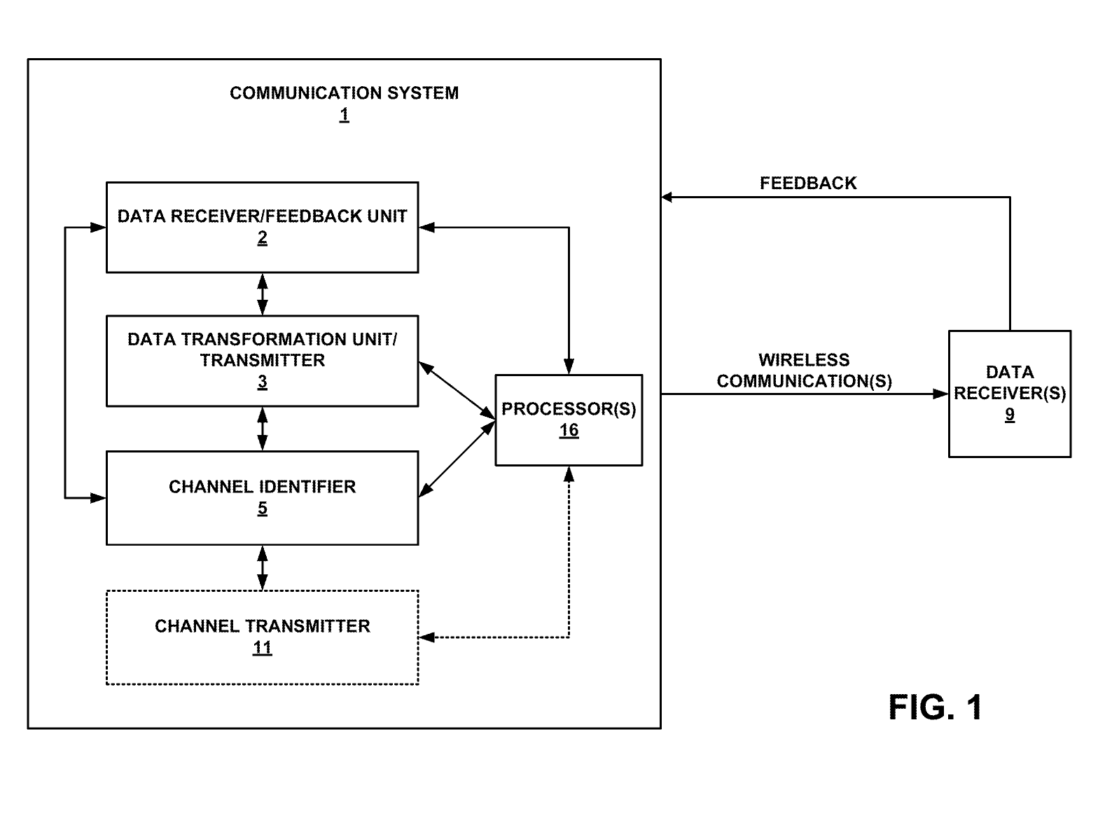

FIG. 1 is a block diagram illustrating an example of a communication system 1, including a data receiver/feedback unit 2, which is communicatively coupled to one or more data receivers 9 via one or more wireless communications. Communication system 1 is capable of sending data to data receivers 9. In some cases, the data may comprise multimedia data including at least one of audio data, video data, text data, speech data, and graphics data. In the example of FIG. 1, although communication system 1 is shown as only sending data to one particular data receiver 9 via one or more wireless communications, communication system 1 may also, in some cases, be capable of sending or broadcasting data to one or more data receivers, including data receivers 9.

In some instances, the wireless communications shown in FIG. 1 between communication system 1 and data receivers 9 may comprise communications supported across a spectrum for a digital broadcast format, such as an Advanced Television Systems Committee (ATSC) format, a Digital Video Broadcasting (DVB) format, a Terrestrial Digital Multimedia Broadcasting (T-DMB) format, an Integrated Services Digital Broadcasting Terrestrial (ISDB-T) format, or a Moving Picture Experts Group Transport Stream (MPEG-TS) format, provided by International Standard ISO/IEC 13818-1, to name only a few, as will be described in more detail below. ATSC standards are a set of standards developed by the Advanced Television Systems Committee for digital television transmission. DVB standards are a suite of internationally accepted, open standards for digital television, and are published by a Joint Technical Committee (JTC) of the European Telecommunications Standards Institute (ETSI), European Committee for Electrotechnical Standardization (CENELEC), and European Broadcasting Union (EBU). DMB is a digital radio transmission technology for sending multimedia data to mobile devices. ISDB is a Japanese standard for digital television and digital radio.

A digital broadcast format may be a broadcast format in which no specific or particular destination is provided in or specified by the transmitted data. For example, a digital broadcast format may comprise a format in which the header of a broadcasted data packet or unit does not include any destination address.

The wireless communications shown in FIG. 1 may comprise infrared or other radio frequency communications. These wireless communications may allow an optional channel transmitter 11 to provide channel information to data receivers 9, as will be described in more detail below.

Communication system 1 may comprise a fixed system of one or more devices, which transmits or receives data at a specified location, or a mobile system of one or more devices. Each device may comprise one or more processors. For example, communication system 1 may comprise one or more processors 16 shown in FIG. 1. Communication system 1 may comprise one or more stand-alone devices or may be part of a larger system. For example, communication system 1 may comprise, or be part of, a wireless communication device (e.g., wireless mobile handset or device), a digital camera, digital television (TV), a video camera, a video telephone, a digital multimedia player, a personal digital assistant (PDA), a video game console, a personal computer or laptop device, or other video device.

In certain examples, communication system 1 may be used for video game or gaming applications. In these examples, one or more users of communication system 1 may play one or more games, including any interactive games with other users via a network connection (e.g., wireless network connection) to communication system 1. Graphics and/or video data for the games, including real-time information, may be provided to data receivers 9, which may then be displayed on a separate display device coupled to data receivers 9 (e.g., a high-definition television or display device). In this fashion, a user may view the display data for a game application on this separate display device.

Communication system 1 may also comprise one or more peripheral devices (e.g., keyboards), including peripheral devices that communicate wirelessly with other devices. In some cases, communication system 1 may include components that are included within one or more integrated circuits, or chips, which may be used in some or all of the devices described above.

As shown in FIG. 1, communication system 1 may include a data transformation unit/transmitter 3, which is coupled to a channel identifier 5. Communication system 1 is capable of receiving, processing, and generating data. For example, communication system 1 may receive data over any of many possible radio or access networks, including cellular, local wireless, or broadcast networks, including for example, ATSC, DVB, ISDB-T, or T-DMB. In some instances, communication system 1 may receive data over a wired interface or via one or more embedded interfaces. The data may also comprise data in an uncompressed format, such as data received via image/video sensors for camera or other camcorder applications. In some examples, the data may include one or more of audio data, video data, graphics data, text data, speech data, or metadata.

Communication system 1 is further capable of broadcasting or otherwise transmitting data to one or more other devices, such as data receivers 9, via the wireless communications. Data transformation unit/transmitter 3 is capable of transforming data into a particular digital broadcast format. For example, data transformation unit/transmitter 3 may be capable of encoding data that complies with a particular digital broadcast format (e.g., ATSC, DVB, ISDB-T, T-DMB, MPEG-TS), modulating and then transmitting the encoded data.

Channel identifier 5 is able to identify at least one available channel of a spectrum, where one or more devices of communication system 1 may be involved in the identification of the at least one available channel. For example, the identification of the at least one available channel may be initiated by one or more devices of communication system 1. In some instances, channel identifier 5 may identify the at least one available channel in an unused and/or unlicensed portion of a broadcast spectrum, such as a digital television broadcast spectrum. In some instances, the at least one available channel may comprise television band “white space.” As specified in the “Second Report and Order and Memorandum Opinion and Order” adopted by the Federal Communications Commission (FCC) on Nov. 4, 2008, and released on Nov. 14, 2008 as FCC Order 08-260, “white space” may comprise unused portions or locations of a broadcast television spectrum that are not currently being used by licensed services, and which therefore may be used by unlicensed radio transmitters.

In some instances, an available channel may comprise a channel that is currently unoccupied. In one example, an available channel may comprise a channel that is not currently being used by any authorized or licensed users, e.g., users licensed by the FCC. In one example, an available channel may comprise a channel that is not currently being used either by licensed users or by unlicensed users, e.g., other white space channel users. In some cases, an available channel may comprise a channel that may be used by a user upon acquiring a secondary license from another licensed user.

Channel identifier 8 may identify one or more available channels that may be needed for data broadcast based upon any specific requirements or needs of applications or services that are executed on, or implemented by, one or more devices of communication system 1. Upon identification of the one or more available channels, transformation unit/transmitter 3 may transmit data (e.g., encoded, modulated, or otherwise transformed data) to data receivers 9, through one or more wireless communications, via the at least one identified available channel. In certain cases, communication system 1 will perform one or more of the above-described actions, either automatically or via user input, based upon the execution of one or more services or applications locally running within communication system 1. Data receivers 9 may include functionality for demodulating and/or decoding the received broadcast data from communication system 1. In some cases, transformation unit/transmitter 3 may broadcast the data to multiple data receivers, including data receivers 9, using the at least one identified available channel.

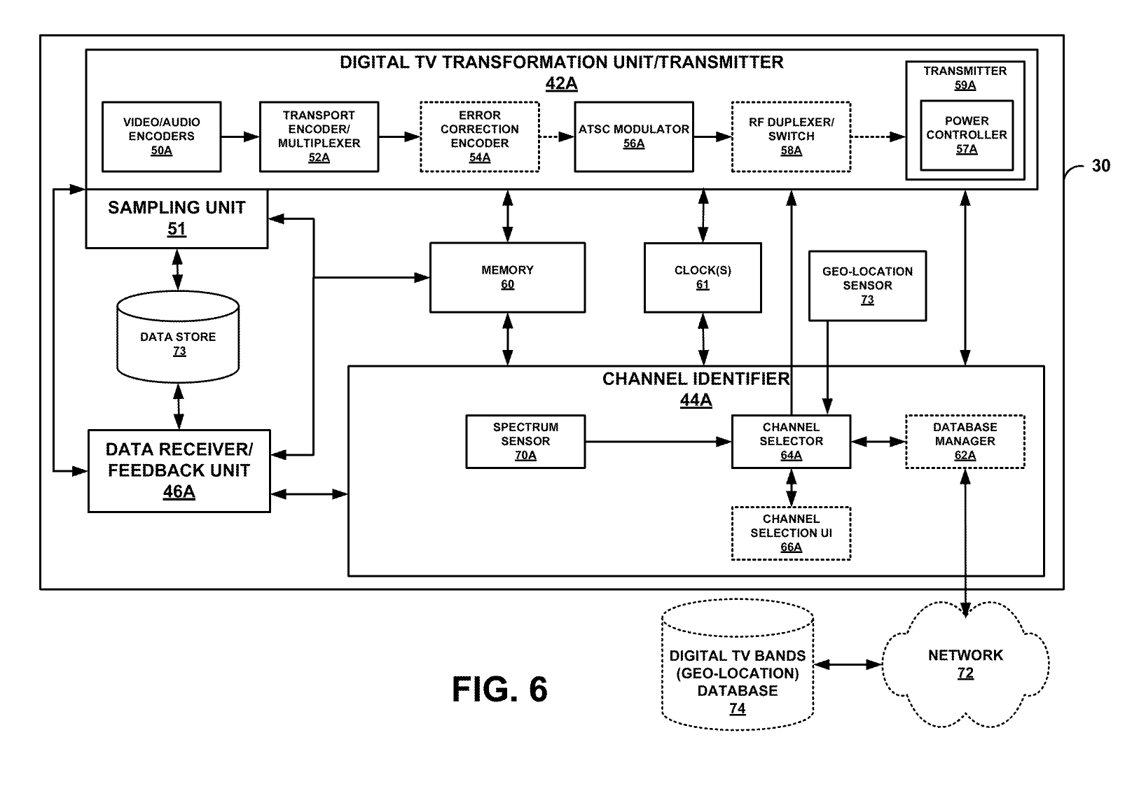

As described above, channel identifier 5 is able to identify at least one available channel of a broadcast spectrum for the particular digital broadcast format. In one example, channel identifier 5 may include a spectrum sensor that is used to identify the at least one available channel by sensing signal information within one or more channel ranges, or bands, within the broadcast spectrum. In one example, channel identifier 5 may access a database (e.g., a digital TV bands database, such as the one shown in FIG. 6) to identify the at least one available channel.

As shown in FIG. 1, communication system 1 may include an optional channel transmitter 11. Communication system 1 is capable of transmitting data over an unused portion of a broadcast spectrum, and switching from one transmission channel to another. For example, communication system 1 may utilize an identified, available channel in an unused portion of a spectrum, and transmit data via this available channel to data receivers 9. In some instances, communication system 1 may need to vacate a particular channel upon subsequent detection of use of the channel by a licensed user. In some instances, communication system 1 may determine that the quality of a channel currently in use is unsatisfactory for further use. In one or more of these instances, communication system 1 may identify a different available channel for use in transmitting further data to data receivers 9. In such cases, channel transmitter 11 is capable of transmitting channel change information to data receivers 9 via one or more wireless communications.

For example, channel identifier 5 may identify a first channel at a first point in time that is available for use by communication system 1 to transmit data. Channel transmitter 11 may send information to data receivers 9 to allow data receivers 9 to determine or identify the first channel. For instance, channel transmitter 11 may send information that directly specifies the first channel or otherwise allows data receivers 9 to determine the first channel based upon the received information.

At a later point in time, communication system 1 may determine to no longer use the first channel. For example, if another user (e.g., licensed user) has taken over occupancy of the first channel, or if the first channel otherwise becomes unavailable or has an unacceptable level of quality (e.g., too much distortion), channel identifier 5 may identify a second, different channel that is currently available for use by communication system 1 in sending subsequent data. Upon identification of such a second channel, channel transmitter 11 is capable of transmitting information using one or more wireless communications to allow data receivers 9 to determine or identify the new, second channel. Data receivers 9 are then capable of receiving data transmissions from communication system 1 over the second channel.

In order to make the channel change with minimal interruption (e.g., to the listening and/or viewing experience of the user), a closed loop control mechanism or protocol may be utilized. Such a control mechanism may comprise an out-of-band means of communication or alternate communication protocol between channel transmitter 11 and data receivers 9 via wireless communication. For example, channel transmitter 11 may utilize an infrared or radio frequency communication to transmit channel change information to data receivers 9, such that data receivers 9 may efficiently change channels with minimal interruption to end users of devices (e.g., display devices) that are included within or otherwise coupled to data receivers 9. In some cases, data transformation unit/transmitter 3 may send some overlap of, or redundant, information across a previously used channel and a newly selected channel to minimize any disruption or impact of data flow processed by data receivers 9.

In some examples, channel transmitter 11 may comprise a low power, low cost infrared (IR) transmitter that may be embedded within a portable device included within communication system 1. Channel transmitter 11 is not limited, however, to provide IR-based communication. For example, channel transmitter 11 may provide any of a variety of radio frequency or wireless communications to data receivers 9. For example, channel transmitter 11 may implement Bluetooth®, ZigBee®, UWB, wireless personal area network (WPAN), or other low power, wireless RF protocols as an alternative to or in addition to IR. Hence, channel transmitter 11 could utilize IR communication, RF communication, or a combination of both.

As shown in FIG. 1, communication system 1 also includes a data receiver/feedback unit 2, which is capable of receiving feedback signals from data receivers 9. In various instances, the use of data receiver/feedback unit 2 allows communication system 1 to receive feedback from data receivers 9 to allow communication system 1 to identify a quality of data transmission that may be provided to data receivers 9. Data transformation unit/transmitter 3, channel identifier 5, data receiver/feedback unit 2, and channel transmitter 11 may be operable by one or more processors, such as one or more processors 16.

In one example, data receiver/feedback unit 2 may receive a representation of the data that was previously transmitted across an identified channel by data transformation unit/transmitter 3. The transmitted data (e.g., audio data) may be a portion of one or more multimedia streams that are transmitted to a data receiver, and the received representation may comprise a representation of this portion (e.g., only the audio portion) of the multimedia streams. Data receiver/feedback unit 2 may compare at least a portion (e.g., one or more samples) of the received representation of the data to at least a portion (e.g., one or more samples) of the transmitted data to assess data integrity/strength of the received representation and to determine whether to adjust a broadcast transmission parameter or a data transformation parameter for use in subsequent data communication based upon the comparison, as will be described in more detail below.

For instance, in one specific, non-limiting scenario described for purposes of illustration only, data receivers 9 may comprise a television device having one or more speakers. The data transmitted to data receivers 9 by data transformation unit/transmitter 3 may include multimedia data, including audio data that may be decoded and rendered by the television device almost instantaneously, except for end-to-end latencies which may be on the order of milliseconds).

Data receiver/feedback unit 2 may then receive and process the rendered audio feedback from data receivers 9. For example, data receiver/feedback unit 2 may compare the received audio signals to the transmitted audio and assess signal distortion to provide information to communication system 1 on the quality of service delivered to data receivers 9. In some cases, if the quality of the received signals falls below a defined threshold (e.g., if there is too much signal distortion in the received audio feedback with respect to the originally transmitted audio), as determined by data receiver/feedback unit 2, data 3 transformation unit/transmitter 3 may increase the transmit power for subsequent data that is transmitted to data receivers 9 in an effort to improve the quality of transmission signals received by data receivers 9, as will be described in more detail below. In some cases, if data receiver/feedback unit 2 determines that the quality of the received signals falls below a defined threshold, channel identifier 5 may identify another available channel for use by data transformation unit/transmitter 3 for further subsequent data transmission.

In some examples, data receiver/feedback unit 2 may take into account any potential expected distortion for data that is, in general, received by communication system 1 when comparing the received audio signals to the transmitted audio and determining whether an additional, unexpected amount of signal distortion has occurred with respect to the received audio signals. For instance, as will be described in further detail below with respect to FIG. 6, data receiver/feedback unit 2 may analyze either the received audio signals, or data received previously by data receiver/feedback unit 2, to determine any amount of distortion that may be expected in received data, such as distortion that may be caused by room acoustics or by one or more of data receivers 9 (e.g., background noise). In these cases, data receiver/feedback unit 2 may dynamically adjust the comparison (e.g., threshold value used for the comparison of the received audio signals to the transmitted audio) in order to determine if the received audio signals have a greater-than-expected amount of distortion.

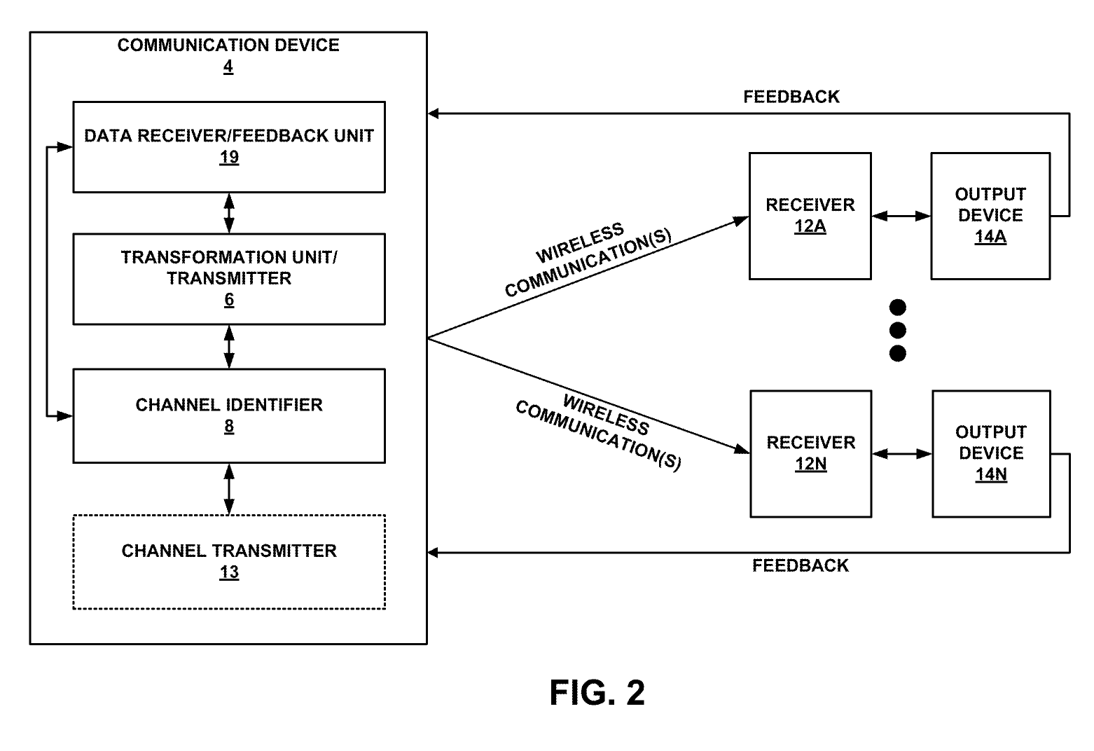

FIG. 2 is a block diagram illustrating an example of a communication device 4, which includes a data receiver/feedback unit 19, being communicatively coupled to one or more communication receivers 12A-12N and one or more output devices 14A-14N via one or more wireless communications. Communication device 4 is capable of sending data (e.g., multimedia data) to one or more of receivers 12A-12N. In some cases, the data may comprise multimedia data including at least one of audio data, video data, text data, speech data, and graphics data.

In the particular example of FIG. 2, transformation unit/transmitter 6, channel identifier 8, data receiver/feedback unit 19, and optional channel transmitter 13 are included within one particular device, namely communication device 4. Transformation unit/transmitter 6, channel identifier 8, data receiver/feedback unit 19, and channel transmitter 13 may be operable by one or more processors, such as one or more processors 16 shown in FIG. 1.

Similar to the wireless communications shown in FIG. 1, the wireless communications shown in FIG. 2 may comprise one or more communications across a broadcast spectrum for a digital broadcast format, such as ATSC, DVB, T-DMB, ISDB-T, or MPEG-TS, to name only a few. Communication device 4 may comprise a fixed device, which transmits or receives data at a specified location, or a mobile device. Communication device 4 may comprise a stand-alone device or may be part of a larger system. For example, communication device 4 may comprise, or be part of, a wireless multimedia communication device (such as a wireless mobile handset), a digital camera, digital TV, a video camera, a video telephone, a digital multimedia player, a personal digital assistant (PDA), a video game console, a personal computer or laptop device, or other video device. Communication device 4 may also be included within one or more integrated circuits, or chips, which may be used in some or all of the devices described above.

The wireless communications shown in FIG. 2 may include infrared or other radio frequency communications. These wireless communications may allow channel transmitter 13 to provide channel information to one or more of receivers 12A-12N.

Communication device 4 is capable of receiving, processing, and generating data, including multimedia data. For example, communication device 4 may receive data over any of many possible radio or access networks, including cellular, local wireless, or broadcast format, including ATSC, DVB, ISDB-T, or T-DMB.

Communication device 4 is further capable of broadcasting data to one or more other devices, such as output devices 14A-14N, via wireless communications. Transformation unit/transmitter 6 is capable of transforming data into a particular digital broadcast format. For example, transformation unit/transmitter 6 may be capable of encoding multimedia data that complies with a particular digital broadcast format (e.g., ATSC, DVB, ISDB-T, T-DMB, MPEG-TS), and modulating the encoded multimedia data.

Channel identifier 8 is able to identify at least one available channel of a spectrum, where the identification is initiated by communication device 4. In some cases, channel identifier 8 may identify multiple available channels that may be needed for transmission based upon any specific requirements or needs of applications or services that are executed on communication device 4. For example, an application or service may request or utilize multiple channels for providing information to a remote destination. In one scenario, an application may transmit a first multimedia data stream to a first one of receivers 12A-12N across a first channel, and may transmit a second multimedia data stream to a second one of receivers 12A-12N across a second, different channel.

In another example, an application or service may utilize multiple channels when sending data to a given one of receivers 12A-12N. In this example, the application or service may transmit a first portion or component of a given data stream to a receiver, but may transmit a second portion or component of the data stream to the same receiver. Transformation unit/transmitter 6 may determine which portions of the data stream are transmitted across which channels in this example.

Upon identification of the one or more available channels, transformation unit/transmitter 6 may transmit the transformed (e.g., encoded, modulated) data to one or more of receivers 12A-12N, via wireless communications, using the at least one identified available channel. In certain cases, communication device 4 will perform one or more of the above-described actions, either automatically or via user input, based upon the execution of one or more services, or applications, locally running on communication device 4.

For example, in one example, an application may determine to broadcast specified multimedia content solely to receiver 12A. Receiver 12A may receive the broadcast data, and may include a tuner that tunes receiver 12A to the appropriate channel through which data is being broadcast from communication device 4. Receiver 12A then provides the received data to output device 14A for processing (e.g., for display).

In another example, an application may determine to broadcast specified multimedia content to multiple ones of receivers 12A-12N. In this case, receivers 12A-12N may each receive the broadcasted data, and may each include a tuner that tunes to the appropriate channel (e.g., frequency or frequency band) through which data is being broadcast from communication device 4. Each receiver 12A-12N then provides the received data to its corresponding output device 14A-14N for processing.

In some cases, receivers 12A-12N may include functionality for demodulating and/or decoding the received broadcast data from communication device 4. In some cases, output devices 14A-14N may include such functionality. One or more of output devices 14A-14N may each comprise an external device with respect its corresponding receiver 12A-12N. In some instances, one or more of output devices 14A-14N may each be part of, or integrated within, its corresponding receiver 12A-12N.

As described above, channel identifier 8 is able to identify at least one available channel of a broadcast spectrum for the particular digital broadcast format. In one example, channel identifier 8 may include a spectrum sensor that is used to identify the at least one available channel by sensing signal information within one or more channel ranges, or bands, within the broadcast spectrum. In one example, channel identifier 8 may access a database (e.g., a digital TV bands database, such as the one shown in FIG. 6) to identify the at least one available channel.

For instance, communication device 4 may include geo-location functionality, whereby communication device 4 is capable of determining its geographic location, e.g., by using a Global Positioning System (GPS) or other similar component, pilot signal or other location techniques. In this instance, communication device 4 may provide such location information to a digital TV bands database. The digital TV bands database may be populated with channel information based upon location, and may be able to provide communication device 4 with a list of any available channels within the geographic region currently occupied by communication device 4.

In some examples, communication device 4 may be capable of determining its geographic location via location estimation using an Internet Protocol (IP) address of communication device 4. Geo-location by IP address is a technique of determining a geographic latitude, longitude, and also potentially city and state of communication device 4 by comparing public IP address of communication device 4 with IP addresses of other electronically neighboring servers, routers, or other devices having known locations. In these examples, communication device 4 may provide its IP address to an external server (e.g., via wireless communication). The external server may access a database containing IP addresses of other devices having known locations. The external server may use techniques to obtain an estimate of the location of communication device 4 by comparing the IP address of communication device 4 to the IP addresses of the devices having known locations within the database, and may then provide this estimated location back to communication device 4. The external server may, in some cases, perform the comparison by determining which devices within the database have IP addresses that most closely match or resemble the IP address of communication device 4.

The broadcast of data from communication device 4 to one or more of output devices 14A-14N may provide certain advantages. For example, local broadcasts from communication device 4 to output devices 14A-14N can be created similar to a distributed transmitter network. Thus, in one scenario, a user may utilize communication device 4 to broadcast multimedia data to other co-located or non-co-located output devices 14A-14N. For instance, a user may set up a wireless network in the user's home to couple communication device 4 to other devices. Communication device 4 may comprise, in one example, a personal or laptop computer.

The user may wish to transmit multimedia data (e.g., a personal presentation, a television show or movie, web content, streaming video, digital photographs), as processed by communication device 4, to one or more of receivers 12A-12N. If output devices 14A-14N comprise one or more televisions, for instance, communication device 4 may identify one or more available channels to broadcast such multimedia data to these one or more televisions, providing a convenient way to extend content from a computer to a television (e.g., large screen and/or high-definition television) without the need for using any wires or other physical connections.

Communication device 4 includes a channel transmitter 13, which may provide functionality that is similar to channel transmitter 11 described in reference to FIG. 1. Channel transmitter 13 is capable of providing information to one or more of receivers 12A-12N that allows the receiver to identify or determine the channel. For instance, channel transmitter 13 may send one or more commands to a data receiver that either directly or indirectly specify a channel or a channel change. The commands may, for example, explicitly identify the channel(s) over which data is to be transmitted from transformation unit/transmitter 6. In other cases, such as when there is a channel change, the commands may indicate a type or direction of channel change with respect to a previously used channel.

Thus, in one scenario, if communication device 4 had previously been transmitting data across a first channel, but determines that it will subsequently send data across a second channel, channel transmitter 13 may send one or more commands to one or more of receivers 12A-12N explicitly identifying the second channel as the new channel. In other cases, channel transmitter 13 may send one or more commands specifying a channel change (e.g., channel up command, channel down command). Receivers 12A-12N are able to identify or determine the new (i.e., second) channel based upon the received commands, and optionally also based upon information regarding the previously used channel, such as in the case of receiving channel-up or channel-down commands.

As shown in FIG. 2, communication device 4 also includes a data receiver/feedback unit 19, which is capable of receiving feedback signals from any one of receivers 12A-12N. In various instances, the use of data receiver/feedback unit 19 may allows communication device 4 to receive feedback from one or more of output devices 14A-14N to allow communication device 4 to identify a quality of data transmission that is provided to the corresponding ones of receivers 12A-12N. With respect to any receiver/output device combination, data receiver/feedback unit 19 may function similarly to data receiver/feedback unit 2 shown in FIG. 1.

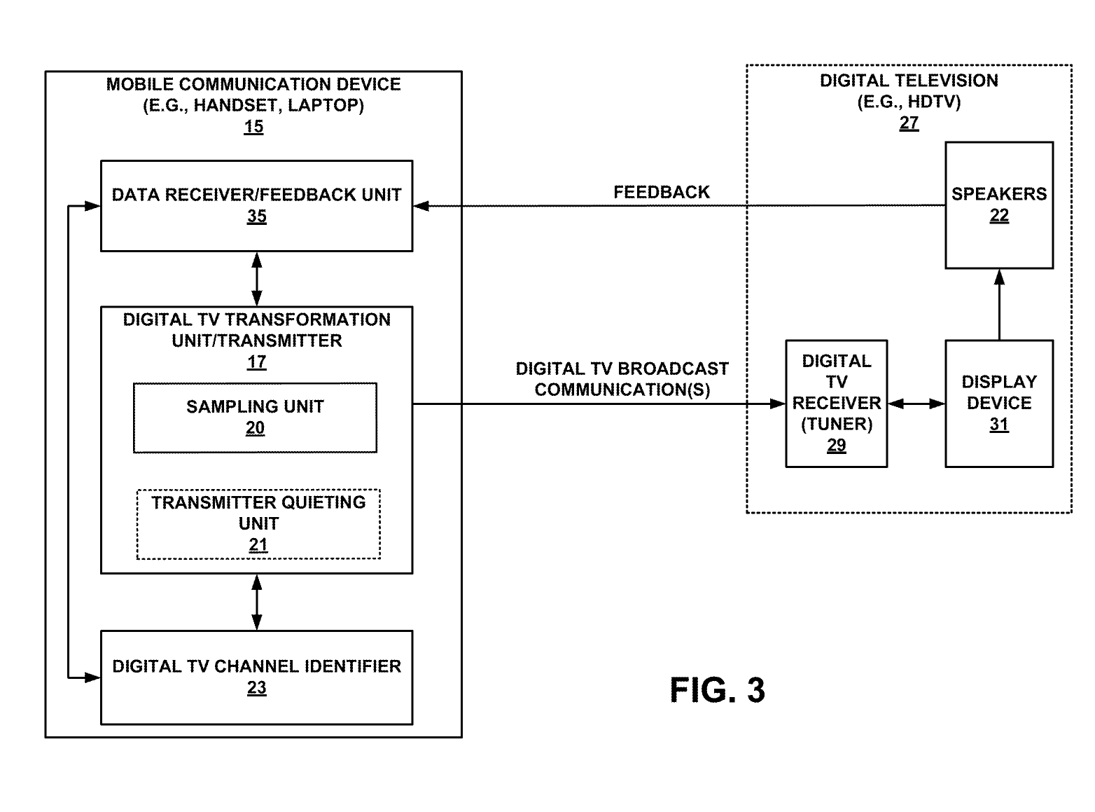

FIG. 3 is a block diagram illustration an example of a mobile communication device 15 (e.g., a mobile handset, a laptop computer) being communicatively coupled to a digital TV receiver 29 and a display device 31, which may be included within a digital TV 27 (e.g., a high-definition television). Mobile communication device 15 may comprise any form of mobile device, such as a mobile communication handset, a personal computer or laptop computer, a digital multimedia player, a personal digital assistant (PDA), a video game console, or other video device.

In FIG. 3, digital TV transformation unit/transmitter 17, digital TV channel identifier 23, and data receiver/feedback unit 35 are shown to be included within the same mobile communication device 15. However, in some alternate examples, these components may be included within a communication system (e.g., system 1 shown in FIG. 1) that includes one or more separate devices, including one or more peripheral devices.

Mobile communication device 15 is capable of receiving, processing, and generating multimedia data. Mobile communication device 15 is further capable of broadcasting multimedia data to digital TV 27 using one or more digital TV broadcast communications. Digital TV transformation unit/transmitter 17 is capable of transforming multimedia data into a digital broadcast format, e.g., encoding multimedia data that complies with a particular digital broadcast TV format, such as ATSC, and modulating the encoded multimedia data.

Digital TV channel identifier 23 is able to identify at least one available TV channel in an unused portion of a broadcast TV spectrum for the particular digital broadcast TV format, where such identification is initiated by mobile communication device 15. In some cases, digital TV channel identifier 23 may identify multiple available channels that may be needed for multimedia broadcast based upon any specific requirements or needs of applications or services that are executed on mobile communication device 15.

Upon identification of the one or more available channels, transformation unit/transmitter 17 may transmit the transformed data (e.g., encoded, modulated multimedia data) to digital TV receiver 29 using the at least one identified available channel. In some cases, mobile communication device 15 will initiate one or more of the above-described operations, either automatically or via user input, based upon the execution of one or more services, or applications, locally running on mobile communication device 15. In some cases, digital TV receiver 29 may be included within digital TV 27.

Digital TV transformation unit/transmitter 17 also includes a transmitter quieting unit 21. If channel identifier 23 includes spectrum sensing functionality, transmitter quieting unit 21 may provide quiet intervals during which time transformation unit/transmitter 17 refrains from transmitting data, such as by temporarily disabling or even turning off the data transmission functions of data transformation unit/transmitter 17. In one example, channel identifier 23 may detect, during at least one time interval, whether at least one channel of a spectrum is available for use. During this at least one time interval, transmitter quieting unit 21 may refrain from transmitting any data, as described in more detail below.

As shown in FIG. 3, mobile communication device 15 may identify one or more available channels to broadcast multimedia data from mobile communication device 15 to digital television 27, providing a convenient way to extend content from a mobile device to a television (e.g., large screen and/or high-definition television) without the need for using any wires or other physical connections. Display device 31 may, in various examples, comprise a flat panel Liquid Crystal Display (LCD), a flat panel plasma display, a projection display device, a projector device, or the like.

As shown in FIG. 3, digital TV transformation unit/transmitter 17 also includes a sampling unit 20. As will be described in more detail below, a sampling unit, such as sampling unit 20, is capable of collecting and/or storing samples of data that is to be transmitted in the one or more digital TV broadcast communications. In some cases, sampling unit 20 is also capable of inserting watermark information into the data stream prior to its transmission. The watermark information may be dynamically generated by sampling unit 20 or pre-stored within mobile communication device 15. As will be described in further detail below, in some examples, the watermark information may comprise audio watermarks, including inaudible watermarks that are imperceptible by the human ear when rendered.

In the example of FIG. 3, display device 31 of digital television 27 is coupled to speakers 22. Speakers 22 are capable of generated audio output for audio data that has been decoded and/or rendered by digital TV receiver 29. The audio output generated by speakers 22 may be received, as feedback, by data receiver/feedback unit 35 of mobile communication device 15, which may function similarly to data receiver/feedback unit 2 (FIG. 1) and/or data receiver/feedback unit 19 (FIG. 2). Data receiver/feedback unit 35 is communicatively coupled to digital TV transformation unit/transmitter 17 and to digital TV channel identifier 23.

Data receiver/feedback unit 35 is capable of receiving a representation of the original data previously transmitted by digital TV transformation unit/transmitter 17 to digital TV receiver 29. Data receiver/feedback unit 35 may then compare at least a portion of the received representation of the data, generated by speakers 22, to at least a portion of the actual data that was previously transmitted to digital TV receiver 29, in an effort to assess data integrity/strength within the received data determine whether to adjust a broadcast transmission parameter or a data transformation parameter for use in subsequent data communication based upon the comparison.

For example, data receiver/feedback unit 35 may determine whether to adjust a transmit power used for subsequent data transmission by digital TV transformation unit/transmitter 17, or may even in some cases adjust a data transformation (e.g., coding) parameter to modify the amount or type of data encoding performed by digital TV transformation unit/transmitter 17. Data receiver/feedback unit 35 may adjust a data transformation parameter either in combination with or in lieu of adjustment a transmission parameter, such as the transmit power.

Data receiver/feedback unit 35 may determine whether any differences between at least a portion of the received representation of the data and at least a portion of the transmitted data exceed a defined threshold that may be indicative of a level of signal distortion. For example, in some cases, identifiable audio dropout or silence caused by missing audio data may be the source of a certain amount of signal distortion, particularly if the current transmit power setting is low or insufficient. In some cases, the distortion may be partial distortion, such as when, for instance, digital TV receiver 29 tries to mask a channel error, either partially reconstructing the audio waveform from received data (e.g. sub-band coding with unequal error protection), or replacing it entirely with another waveform different from what was transmitted by digital TV transformation unit/transmitter 17.

In certain instances, data receiver/feedback unit 35 may analyze at least the portion of the received representation of the data and at least the portion of the transmitted data to determine (e.g., measure, estimate) round-trip signal propagation delay, audio multipath characteristics, audio loudness, and/or room equalization characteristics. If the delay is long, if there are multiple paths, if the received data (e.g., audio data) is weak, or if the received data includes much frequency distortion, the further away digital TV 27 may potentially be with respect to mobile communication device 15, in which case transmit power could be increased to improve one or more of these characteristics. Some of these estimates or measurements could be enhanced if audio watermarks are used to serve as reference or timing sources. Audio watermarks are described in further detail below. Audio watermarks may be valuable in those scenarios in which the audio volume is low to begin with or there are longer silent periods.

If data receiver/feedback unit 35 determines that the differences exceed the defined threshold, digital TV transformation unit/transmitter 17 may transmit additional data via the at least one identified channel with increased power in an effort to improve the quality/fidelity of the signals received by digital TV receiver 29. In some instances, data receiver/feedback unit 35 may, upon determining that differences between received and transmitted signals exceed a defined threshold, cause digital TV channel identifier 23 to identify another, different available channel in the digital TV broadcast spectrum, in an effort to reduce interference between signals transmitted by digital TV transformation unit/transmitter 17 and other signals. Digital TV transformation unit/transmitter 17 may subsequently transmit further data in the newly identified channel.

For instance, in one example, digital TV transformation unit/transmitter 17 may first attempt to increase its transmit power for data transmitted upon determination by data receiver/feedback unit 35 that there is a defined amount of distortion based upon the audio feedback received from speakers 22, in comparison to the original data transmitted by digital TV transformation unit/transmitter 17. In some example scenarios, digital TV transformation unit/transmitter 17 may increase the transmit power by a factor of two or four.

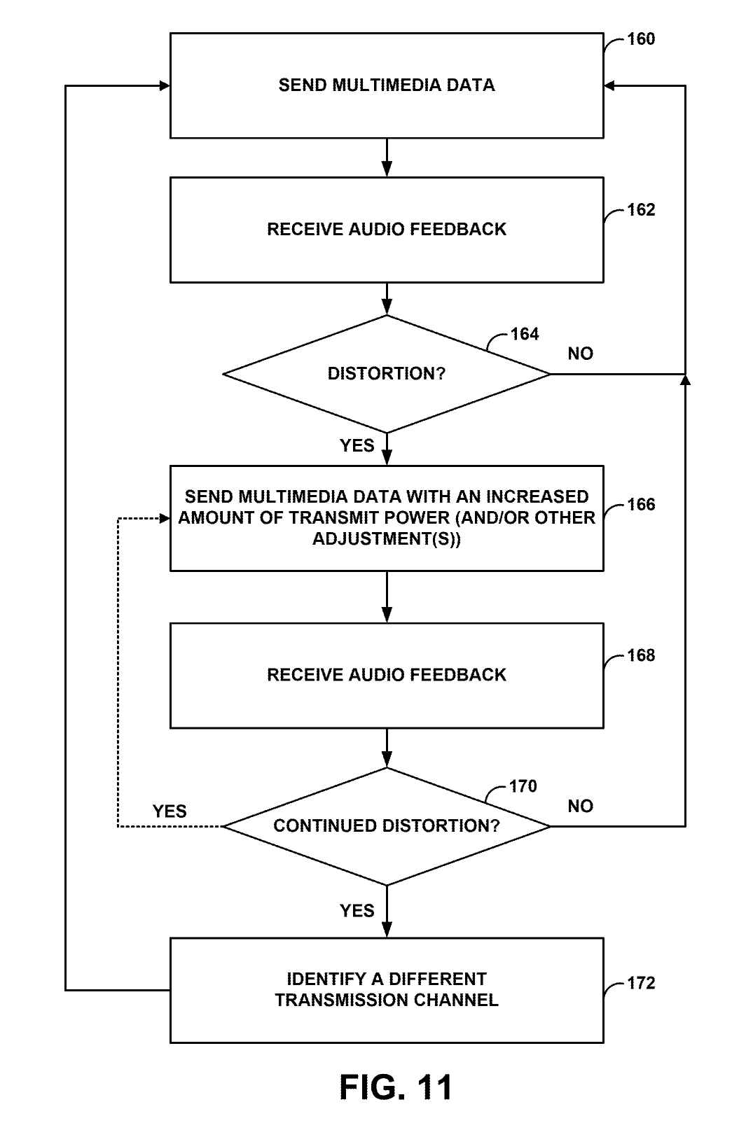

However, if data received/feedback unit 35 continues to detect distortion in the received signal information generated by speakers 22, in relation to the data transmitted by digital TV transformation unit/transmitter 17 with increased transmission power, data receiver/feedback unit 35 may initiate digital TV channel identifier 23 to identify another available channel (e.g., as illustrated in the flow diagram of FIG. 11). In some cases, digital TV transformation unit/transmitter 17 may attempt multiple iterations in increasing transmit power for data communication to digital TV receiver 29 before digital TV channel identifier 23 identifies a different available channel for subsequent data transmission. By selectively increasing transmit power and/or selecting different transmit channels, mobile communication device 15 may utilize the feedback received from digital television 27 to improve the quality of data that is received and processed by digital TV receiver 29.

In some examples, data receiver/feedback unit 35 may interact with digital TV transformation unit/transmitter 17 to iteratively increase the transmit power over multiple cycles, in small increments (e.g., by a factor of 1.5 or 2 every second). During each cycle, data receiver/feedback unit 35 may determine, based upon received audio feedback, whether there is continued signal distortion. Digital TV transformation unit/transmitter 17 may increase transmit power in small increments in an effort to improve signal fidelity and reduce signal distortion in the received signal, while not necessarily overly amplifying the transmission data signal stream(s).

In some examples, if the signal distortion persists after increasing the transmit power over multiple cycles, digital TV channel identifier 23 may identify a new available channel for subsequent data transmission, given that the current channel may potentially have interference issues with other transmissions (e.g., transmissions from nearby sources).

Data receiver/feedback unit 35 may also determine whether to adjust a transmit power used for subsequent data transmission by digital TV transformation unit/transmitter 17 based upon other forms of analysis of the received feedback data. For example, data receiver/feedback unit 35 may determine and/or monitor a propagation delay between a time at which digital TV transformation unit/transmitter 17 transmits the source data and a time at which data receiver/feedback unit 35 detects the received audio feedback comprising a representation of one or more portions of the transmitted data.

If data receiver/feedback unit 35 detects that mobile communication device 15 may be further away from digital TV 27 based upon the determined signal propagation delay, digital TV transformation unit/transmitter 17 may increase the transmit power for subsequent data communication. As one example, data receiver/feedback unit 356 may monitor, over time, the propagation delay parameter. If the value of the parameter increases over time, data receiver/feedback unit 35 may determine that the distance between mobile communication device 15 and digital TV 27 is increasing, and may therefore communicate with digital TV transformation unit/transmitter 17 to increase the transmit power based upon the increased distance between devices.

Similarly, digital TV transformation unit/transmitter 17 may increase the transmit power for subsequent data communication to digital TV 27 if data receiver/feedback unit 35 detects a decrease in signal strength of the received feedback (e.g., a decrease indicative of a change in loudness of volume of received audio feedback). As one example, data receiver/feedback unit 356 may monitor, over time, the signal strength of the received feedback. If the value of signal strength decreases over time, digital TV transformation unit/transmitter 17 may increase the transmit power. Digital TV transformation unit/transmitter 17 may also measure or estimate other characteristics, such as audio multipath characteristics and/or room equalization characteristics, when determining whether to increase transmit power for subsequent data communications to digital TV 27. Some of these estimates or measurements could be enhanced through the use of audio watermarks that may serve as reference and/or timing sources, as will be described in further detail below. For example, the use of audio watermarks may be valuable when the audio volume is low to begin with or there is a long silent period.

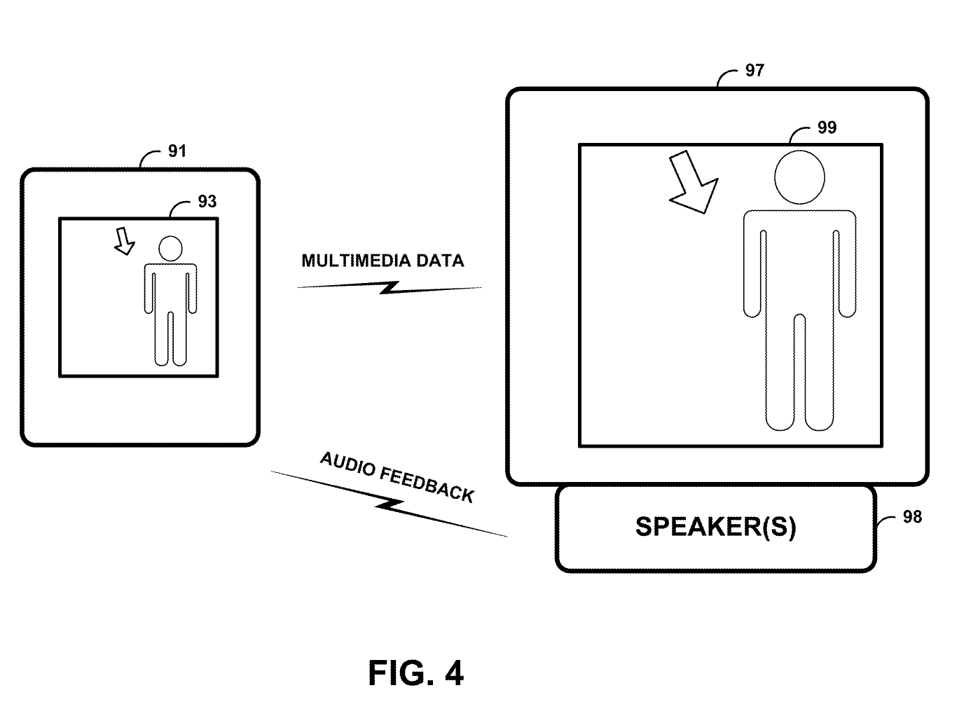

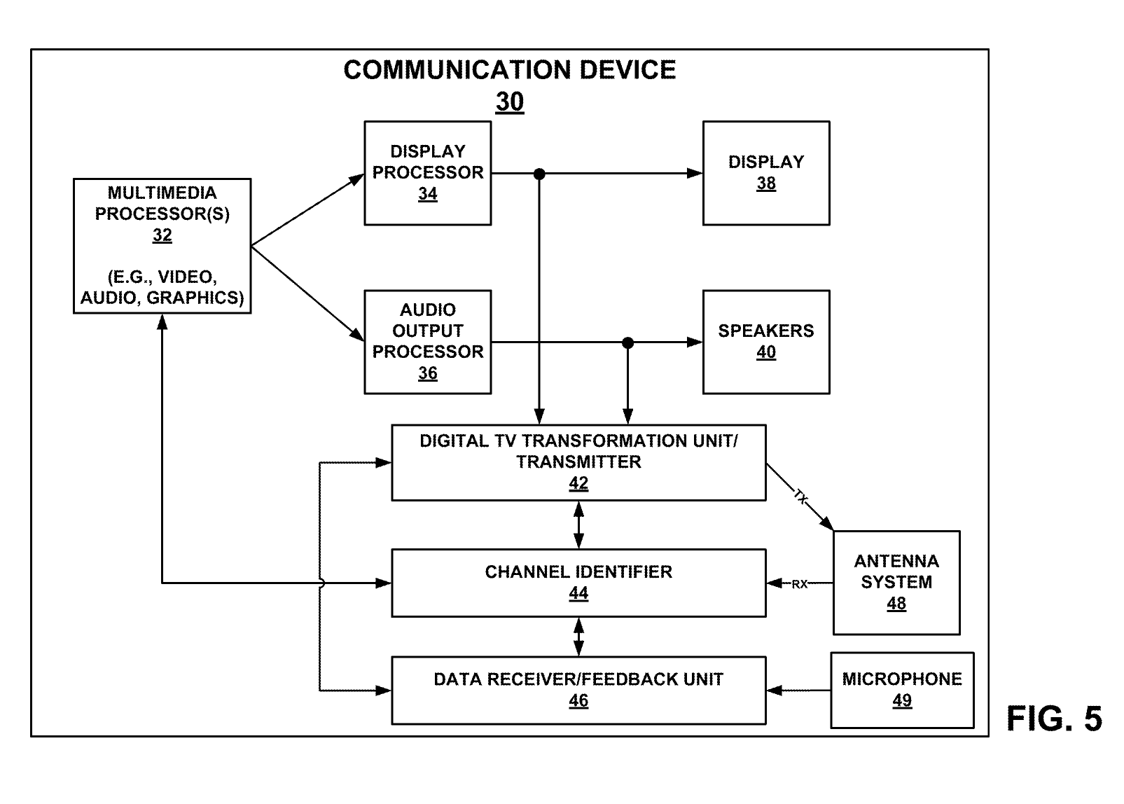

FIG. 4 is a conceptual diagram illustrating an example of multimedia data being wirelessly transmitted from a device 91 to a TV 97. In this example, device 91 may comprise a communication device, such as communication device 50 shown in FIG. 5. TV 97 may comprise a digital TV, such as digital TV 27 shown in FIG. 3.

Device 91 includes a display 93, and TV 97 includes a display 99. In some examples, device 91 may comprise a mobile device (e.g., handset, smartphone, laptop). TV 97 may comprise a digital HDTV. TV 97 may or may not include an embedded, or integrated, receiver/tuner. TV 97 is coupled to one or more speakers 98. In some examples, speakers 98 are integrated within TV 97. In some examples, one or more of speakers 98 may comprise speakers that are external to TV 97 (e.g., speakers situated within one or more rooms proximate to TV 97).

FIG. 4 illustrates how device 91 may wirelessly communicate with TV 97 to provide multimedia (e.g., graphics, video, audio, and/or interactivity data) to TV 97. Display 93 includes an image of a person, and further includes an arrow icon. The arrow icon may comprise a cursor that is movable via input from a user, such as via manipulation of a touch-screen or other input device, to select or identify portions of the displayed image data. Device 91 is capable of wirelessly transmitting the image and user interactivity/ancillary data (e.g., movement of the arrow icon) to TV 97 via a wireless (e.g., broadcast) transmission, such as via the wireless communications shown in FIGS. 1-3.

As a result, a user may utilize a touch-screen (e.g., for screen 93) to control a movement of a cursor, or icon, on screen 99 of TV 97, such as the arrow shown in FIG. 4. Icons used for cursors may be user selectable or definable for purposes of customization. For example, a user may select a cursor icon from a number of pre-existing icons, or may define or create a user-specific icon. In some examples, closed captioning and subtitle functions that may already exist or be supported in a tuner/receiver of TV 97 may be utilized to encapsulate or transport touch control metadata. For instance, headers or data structures that may otherwise be utilized for closed captioning or subtitle information may instead include touch control information, or metadata, related to the control and movement of an icon or cursor on the display screen.

In such fashion, a user is able to wirelessly extend the display 93 of device 91 to TV 97. In some instances, devices 91 and TV 97 may be located in general proximity, such as in the same room, house, or general area. If display 93 is too small or limiting, for example, the user may wish to view the display data on a much larger display 99 of TV 97, which may provide higher image resolution as well. Any interactivity with the arrow icon on display 93 may also be captured and displayed on display 99.

In some cases, a user of device 91 may wish to view data on both display 93 and display 99. However, because display 93 may have some limitations with respect to resolution, size, and other factors, a user may also disable display functionality on display 93 while displaying data on display 99 (e.g., if device 97 comprises a large-screen HDTV). For example, if the data to be displayed on screen 93 is very large and may not entirely fit on screen 93 for easy viewing, a user may wish to disable display functionality on display 93 and only view such information on display 99 of TV 97.

As shown in the conceptual diagram of FIG. 4, speakers 98 may also generate audio feedback that may be received and processed by device 91. The processing of such audio feedback by device 91 may allow device 91 to identify a quality of multimedia data transmission that is provided to TV 97.

In one example, device 91 may receive a representation of audio data that was previously transmitted across an identified channel from device 91 to TV 97. The representation of the audio data may comprise the audio feedback generated by speakers 98 based upon the audio information contained in the multimedia data received by TV 97 from device 91. TV 97 may decode and/or render the received audio data, which may then be used by speakers 98 to provide the representation of the data, audio feedback, which is detected and processed by device 91. Device 91 may compare at least a portion of the received representation of the audio data to at least a portion of the audio data included within the previously transmitted multimedia data and determine whether to adjust a broadcast transmission parameter or a data transformation parameter for use in subsequent data communication based upon the comparison.

For instance, device 91 may compare the received audio feedback to the transmitted audio and assess signal distortion to provide information to device 91 on the quality of service delivered to TV 97. In some cases, if the quality of the received feedback falls below a defined threshold (e.g., if there is too much signal distortion), device 91 may increase the transmit power for subsequent data that is transmitted to TV 97, and/or adjust a coding parameter for subsequent data transformation/coding operations. In some cases, if device 91 determines that the quality of the received signals falls below a defined threshold, device 91 may identify another available channel for use in subsequent data transmission.

FIG. 5 is a block diagram illustrating an example of a communication device 30 that may be used as the communication device shown in any of FIGS. 1-3 or as device 91 shown in FIG. 4. As shown in the example of FIG. 5, communication device 30 includes various components. For example, in this particular example, communication device 30 includes one or more multimedia processors 32, a display processor 34, an audio output processor 36, a display 38, speakers 40, a digital TV transformation unit/transmitter 42, and a channel identifier 44. Multimedia processors 32 may include one or more video processors, one or more audio processors, and one or more graphics processors. Each of the processors included within multimedia processors 32 may include one or more decoders.

Multimedia processors 32 are coupled to both display processor 34 and audio output processor 36. Video and/or graphics processors included within multimedia processors 32 may generate image and/or graphics data that is provided to display processor 34 for further processing and display on display 38. For example, display processor 34 may perform one or more operations on the image and/or graphics data, such as scaling, rotation, color conversion, cropping, or other rendering operations. Any audio processors included within multimedia processors 32 may generate audio data that is provided to audio output processor 36 for further processing and output to speakers 40. A user of communication device 30 is thus able to view and hear representations of the multimedia data via display 38 and speakers 40.

In addition to providing output multimedia data to display 38, display processor 34 may also provide its output to digital TV transformation unit/transmitter 42. Further, audio output processor 36 may provide its output to digital TV transformation unit/transmitter 42. As a result, digital TV transformation unit/transmitter 42 is capable of processing multiple streams of multimedia data. In some instances, display processor 34 and/or audio output processor 36 may store corresponding output multimedia data in one or more buffers, which are then accessed by digital TV transformation unit/transmitter 42 to retrieve the data. Digital TV transformation unit/transmitter 42 may include various components, as described in more detail below with reference to FIGS. 6-8, for transforming multimedia data into a particular digital broadcast form (e.g., encoding, modulating the data), and transmitting the transformed data to another device via one or more identified available channels. Digital TV transformation unit/transmitter 42 may transmit data via antenna system 48, which may comprise one or more antennae.

In some cases, digital TV transformation unit/transmitter 42 may transform and/or encapsulate multiple received streams of multimedia data from display processor 34 and audio output processor 36 into individual single program transport streams that may be transmitted over multiple broadcast channels. In some cases, the multiple streams of multimedia data may be encapsulated in the same transport stream and transmitted in a single channel. One multimedia stream may be transmitted as a picture-in-picture (PIP) data path that includes supplemental multimedia information or metadata with respect to the multimedia data. Metadata may include, for example, one or more of text, notification messages, program guide information, or menu information. In certain cases, digital TV transformation unit/transmitter 42 may receive data directly from multimedia processors 32. In these cases, digital TV transformation unit/transmitter 42 may transform and/or encapsulate the data received directly from multimedia processors into transport streams that may be transmitted.

In order for communication device 30 to be able to broadcast or otherwise transmit multimedia data in one or more streams to a remote device using one or more wireless communications, communication device 30 identifies one or more available channels in an unused portion of a spectrum upon initiation by communication device 30. Channel identifier 44 is capable of identifying these one or more available channels.

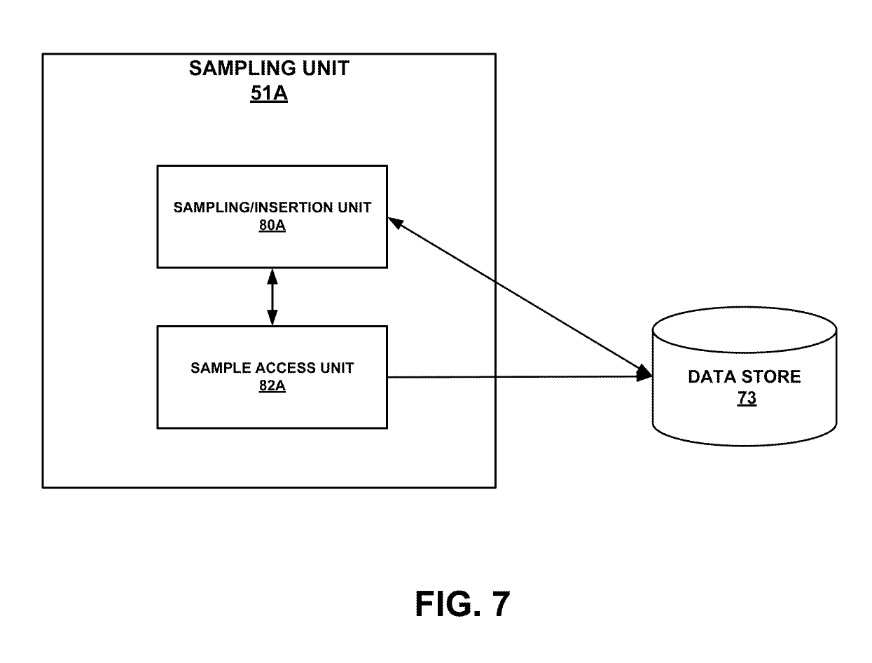

Channel identifier 44 may identify available channels in one or more ways. For example, channel identifier 44 may utilize a spectrum sensor, such as the spectrum sensor shown in FIG. 6 or FIG. 7, which is able to dynamically sense available channels in one or more frequency bands via antenna system 48. The spectrum sensor may be able to assign certain quality values with respect to the sensed signals (e.g., interference levels, signal-to-noise ratios) in order to determine the quality of any available channels within the spectrum for data transmission. The sensing algorithm may be carried out periodically and may be based on the format of a particular video stream being processed.

Channel identifier 44 may also utilize, either in conjunction with spectrum sensing or independently, geo-location functionality. Geo-location refers to the capability of communication device 30 to determine its geographic coordinates through the use of a geo-location sensor (such as the one shown in FIG. 6), which may comprise, in one example, a GPS sensor. Channel identifier 44 may query an external digital channel database (e.g., a digital TV bands database, such as the one shown in FIG. 6) to obtain a list of available channels via wireless communication. Typically, such an external database may be maintained by one or more external devices or sources, but may be updated based upon requests and data flow from various devices, such as communication device 30.

In one example, channel identifier 44 may send geo-location coordinates regarding the location of communication device 30 to the external digital channel database, such as via one or more wireless communications. Channel identifier 44 may then receive, from the external database, a list of available channels for a geographic region associated with the location of communication device 30, as indicated by the geo-location coordinates. Channel identifier 44 may then select one or more of the identified channels for use, and send data back to the external database regarding the intended use of these frequency channels by communication device 30. The external database may therefore be updated accordingly based upon the received data from communication device 30.

In some cases, the external database, once updated, may indicate that the selected channels are in use by communication device 30 until communication device 30 sends a subsequent message to the external database indicating that the channels are no longer needed or being used. In other cases, the external database may reserve the selected channels for device 30 only for a defined interval of time. In these cases, communication device 30 may need to send a message to the external database within the defined interval of time indicating that device 30 is still using the selected channels, in which case the external database will renew the reservation of the selected channels for a second interval of time for use by device 30.

Channel identifier 44 may, in some cases, identify one or more available channels based upon information received from multiple sources. For example, if channel identifier 44 utilizes both a spectrum sensor and geo-location functionality, channel identifier 44 may need to process channel information from both of these sources when determining which channels may be available for use.

Upon identification of one or more available transmission channels by channel identifier 44, digital TV transformation unit/transmitter 42 may then broadcast or otherwise transmit the multimedia content or data to an external device via a network using the identified transmission channel(s). Communication device 30 may initiate the broadcast transmission directly with such an external device.

As shown in FIG. 5, communication device 30 further includes a data receiver/feedback unit 46, which is communicatively coupled to both channel identifier 44 and digital TV transformation unit/transmitter 42. Data receiver/feedback unit 46 may include functionality similar to that of data receiver/feedback unit 2 (FIG. 1), data receiver/feedback unit 19 (FIG. 2), and/or data receiver/feedback unit 35 (FIG. 3).

Data receiver/feedback unit 46 may receive a representation of audio data that was previously transmitted from digital TV transformation unit/transmitter 42 via an available channel identified by channel identifier 44. Microphone 49 of communication device 30 may detect the representation of the audio data, which may comprise audio feedback signals generated by one or more speakers (e.g., speakers 22 of FIG. 3, speakers 98 of FIG. 4) coupled to a receiving device, based upon the audio information contained in the multimedia data transmitted by digital TV transformation unit/transmitter 42 to the receiving device. Data receiver/feedback unit 46 may compare at least a portion of the received representation of the audio data to at least a portion of the audio data included within the previously transmitted multimedia data and determine whether to adjust a broadcast transmission parameter (e.g., transmit power, transmission channel) or a data transformation parameter for use in subsequent data communication by digital TV transformation unit/transmitter 42, as described further below.

FIG. 6 is a block diagram illustrating an example of a digital TV transformation unit/transmitter 42A, in conjunction with a channel identifier 44A, which may be implemented within communication device 30 shown in FIG. 5. In FIG. 6, digital TV transformation unit/transmitter 42A may be one example of digital TV transformation unit/transmitter 42 shown in FIG. 5, channel identifier 44A may be one example of channel identifier 44 shown in FIG. 5, and data receiver/feedback unit 46A may be one example of data receiver/feedback unit 46 shown in FIG. 5. In the particular example of FIG. 6, communication device 30 may be capable of broadcasting multimedia data according to a specific digital broadcast format, ATSC.

Communication device 30 may facilitate low-power transmission to an ATSC-ready external device, such as a high-definition or flat-panel television. In this case, the ATSC-ready device may comprise one of the output devices 14A-14N shown in FIG. 2. The ATSC-ready device may, in some examples, include a display device, speakers, and a tuner/receiver. In these examples, the ATSC-ready device may comprise digital TV receiver 29, display device 31, and speakers 22 shown in FIG. 3.

As shown in FIG. 6, digital TV transformation unit/transmitter 42A may include various components, such as video and/or audio encoders 50A, transport encoder/multiplexer 52A, an optional error correction encoder 54A, ATSC modulator 56A, an optional radio frequency (RF) duplexer/switch 58A, and transmitter 59A. These components help support data transmission over a spectrum implementing the ATSC standard. The ATSC standard is a multi-layered standard that provides layers for video encoding, audio encoding, transport streams, and modulation. In one example, RF duplexer/switch 58A may comprise an ultrahigh frequency (UHF) duplexer/switch. A duplexer may allow for signals to be received for sensing purses and to be transmitted for communication purposes.

Video/audio encoders 50A may include one or more video encoders and one or more audio encoders to encode video and/or audio data into one or more streams. For example, video/audio encoders 50A may include a Moving Picture Experts Group-2 (MPEG-2) encoder or a H.264 encoder (from the Telecommunication Standardization Sector, ITU-T) to encode video data. Video/audio encoders 50A may also include a Dolby Digital (Dolby AC-3) encoder to encoder audio data. An ATSC stream may contain one or more video programs and one or more audio programs. Any of the video encoders may implement a main profile for standard definition video or a high profile for high-definition resolution video.

Transport (e.g., MPEG-2 Transport Stream, or TS) encoder/multiplexer 52A receives the encoded data streams from video/audio encoders 50A and is capable of assembling these data streams for broadcast, such as into one or more packetized elementary streams (PESs). These PESs may then be packetized into individual program transport streams. Transport encoder/multiplexer 52A may optionally, in some instances, provide the output transport streams to an error correction encoder 54A (e.g., a Reed-Solomon encoder), which may perform error correction encoding functionality by adding one or more error correction codes associated with the transport streams. These error correction codes may be used by a data receiver (e.g., data receivers 9 containing error correction unit 11) for error correction or mitigation.

ATSC modulator 56A is capable of modulating the transport streams for broadcast. In some example cases, for instance, ATSC modulator 56A may utilize 8 vestigial side band (8VSB) modulation for broadcast transmission. RF duplexer/switch 58A may then duplex the transport streams, or act as a switch for the transport streams. Transmitter 59A is capable of broadcasting one or more transport streams to one or more external devices using one or more available channels that are identified by channel identifier 44A.

Channel identifier 44A includes an optional database manager 62A, a channel selector 64A, an optional channel selection user interface (UI) 66A, and a spectrum sensor 70A. Both channel identifier 44A and digital TV transformation unit/transmitter 42A are coupled to a memory 60, which may comprise one or more buffers. Channel identifier 44A and digital TV transformation unit/transmitter 42A may exchange information directly, or may also exchange information indirectly through the storage and retrieval of information via memory 60.

Channel identifier 44A includes a spectrum sensor 70A. As discussed previously, a spectrum sensor, such as spectrum sensor 70A, is capable of sensing signals in one or more frequency bands within a broadcast spectrum for a particular digital TV format, such as ATSC. Spectrum sensor 70A may determine channel availability and signal strengths based upon its ability to identify any data that occupies one or more used channels within the spectrum. Spectrum sensor 70A may then provide information to channel selector 64A as to the channels that are currently unused, or available. For example, spectrum sensor 70A may detect that a particular channel is available if it does not detect any data being broadcast on this channel by any external, separate devices.

As shown in FIG. 6, channel selector 64A may also receive information from an optional digital TV bands database via network 72 and database manager 62A. Digital TV bands database 74 is located external to communication device 30A and includes information regarding channels that are currently in use or available within the broadcast spectrum for a particular digital TV format, such as ATSC. Typically, the digital TV bands database 74 is updated dynamically as channels are put into use or freed for use by other devices. In some instances, digital TV bands database 74 may be organized by geographic location/region or by frequency bands (e.g., low VHF, high VHF, UHF).

In order for channel identifier 44A to obtain channel availability information from digital TV bands database 74, channel identifier 44A may, in some cases, provide geo-location information as input into digital TV bands database 74. Channel identifier 44A may obtain geo-location information or coordinates from geo-location sensor 73, which may indicate the geographic location of communication device 30A at a particular point in time. Geo-location sensor 73 may, in some examples, comprise a GPS sensor.

Upon receipt of geo-location information from geo-location sensor 73, channel selector 64A may provide such information, as input, to digital TV bands database 74 via database manager 62A. Database manager 62A may provide an interface to digital TV bands database 74. In some cases, database manager 62A may store a local copy of selected contents of digital TV bands database 74 as they are retrieved. In addition, database manager 62A may store select information provided by channel selector 64A to digital TV bands database 74, such as geo-location information.

Upon sending geo-location information pertinent to communication device 30A, channel selector 64A may receive from digital TV bands database 74 a set of one or more available channels as presented listed within digital TV bands database 74. The set of available channels may be those channels that are available in the geographic region or location presently occupied by communication device 30A, as indicated by geo-location sensor 73.

Upon receipt of available channel information from either or both of spectrum sensor 70A and digital TV bands database 74, channel selector 64A may select one or more available channels, either automatically or via user input via channel selection UI 66A. Channel selection UI may present available channels within a graphical user interface, and a user of a service or application may select one or more of these available channels.

In some instances, channel selector 64A may automatically select or identify one or more of the available channels that are to be used for broadcast transmission by communication device 30A. For example, channel selector 64A may utilize information provided by one or more of multimedia processors 32 (FIG. 5) to determine which one or more of available channels to identify for broadcast transmission. In some cases, channel selector 64A may select multiple channels based upon the demands or needs of the services or applications that are executing. One or more transport streams associated with these services or applications may be broadcast across one or more of the identified channels by transmitter 59A.

In some cases, database 74, once updated, may indicate that the selected channels are in use by communication device 30A until communication device 30A sends a subsequent message to database 74 indicating that the channels are no longer needed or being used. In other cases, database 74 may reserve the selected channels for communication device 30A only for a defined interval of time. In these cases, communication device 30A may send a message to database 74 within the defined interval of time indicating that device 30A is still using the selected channels, in which case database 74 will renew the reservation of the selected channels for a second interval of time for use by communication device 30A.

One or more clocks 61 may be included within communication device 30A. As shown in FIG. 6, clocks 61 may be utilized by, or drive the operation of, digital TV transformation unit/transmitter 42A and channel identifier 44A. Clocks 61 may be configured or set by communication device 30A. In some cases, clocks 61 may be configured by or synchronized to a clock that is external to device 30A. For example, device 30A may receive clock or timing information from an external device (e.g., via geo-location sensor 73) and may configure or synchronize clocks 61 based upon the received information.

For example, in some scenarios, communication device 30A may implement clock functionality that is common with a receiving device (e.g., one of data receivers 9 of FIG. 1, for example). In these scenarios, both communication device 30A and the receiving device may receive clock or timing information from an external device and synchronize their own internal clocks based upon the received information. In this manner, communication device 30A and the receiving device may effectively operate using a common clock. Digital TV transformation unit/transmitter 42A and channel identifier 44A may also utilize clocks 61 to synchronize or align certain operations.

As also shown in the example of FIG. 6, communication device 30 further includes a data receiver/feedback unit 46A, which is one example of data receiver/feedback unit 46 shown in FIG. 5. Data receiver/feedback unit 46A is communicatively coupled to both channel identifier 44A and digital TV transformation unit/transmitter 42A, as well as to sampling unit 51. In addition, data receiver/feedback unit 46A is coupled to a data store 73.

Communication device 30 further includes a sampling unit 51. In some aspects, sampling unit 51 may be part of digital TV transformation unit/transmitter 42A. In some aspects, sampling unit 51 may be separate from, yet communicatively coupled with, digital TV transformation unit/transmitter 42A. Sampling unit 51 may be responsible for periodically sampling the data (e.g., multimedia data) that is to be transmitted by transmitter 59A, and storing these samples within data store 73. Sampling unit 51 may determine how much data is included within each stored sample, as well as how often to perform sampling. Over time, sampling unit 51 may determine how long to store samples within data store 73, and may delete old samples from data store 73 that may no longer be needed by communication device 30. Various parameters (e.g., sample size, sampling frequency, sample storage time) may comprise configurable parameters that may be set by sampling unit, digital TV transformation unit/transmitter 42, and/or data receiver/feedback unit 46A.

In some examples, sampling unit 51 may insert one or more watermarks into the data to be transmitted, which may then potentially be detected in the received signal data processed by data receiver/feedback unit 46A. Sampling unit 51 may determine how often to insert these watermarks into the data. In some instances, sampling unit 51 may retrieve the content of the watermark data that is to be inserted into the data from data store 73. In these instances, the watermark data may be pre-defined or pre-configured data. In other instances, sampling unit 51 may dynamically create or compute the watermark data that is to be inserted. Each of one or more of the watermarks may comprise a bitstream or code that is inserted into the data to be transmitted. In some cases, bits of a given watermark may be interleaved across data bits in the data that is to be transmitted.

For instance, sampling unit 51 may compute one or more pseudo-noise sequences (e.g., spread-spectrum sequences) that are dynamically inserted into the transmission data. These sequences may comprise arbitrary or random sequences of bits. In some examples, the watermarks may comprise audio watermarks that are inserted into audio data within the data to be transmitted. The audio watermarks may, in various cases, comprise inaudible audio, such that when these watermarks are rendered and output (e.g., by one or more speakers), they are imperceptible by the human ear. Sampling unit 51 may store the watermarks as part of the samples that are stored in data store 73. Sampling unit 51 may store these watermarks in addition to, or in lieu of, the samples of the actual transmission data within data store 73, as will be described in more detail below.

In some aspects, sampling unit 51 may insert watermarks into and/or obtain samples of the transmission data prior to the data being passed to video/audio encoders 50A. In some alternate aspects, sampling unit 51 may insert watermarks into and/or obtain samples of the transmission data after the data has been processed by one or more of video/audio encoders 50A, transport encoder/multiplexer 52A, or error correction encoder 54A. In these alternate aspects, the sampled data may comprise encoded/compressed data, and any inserted watermarks are inserted into the encoded/compressed data.

Data receiver/feedback unit 46A allows communication device 30 to receive feedback (e.g., audio signal feedback) from a data receiver that has received and processed the data transmitted from digital TV transformation unit/transmitter 42A, which may then allow communication device 30 to identify the quality/fidelity of data transmission that is provided to this data receiver across the identified channel.

In one example, data receiver/feedback unit 46A may receive a representation of the data (e.g., audio signal feedback) that was previously transmitted across an identified channel by digital TV transformation unit/transmitter 42A. A microphone (e.g., microphone 49 of FIG. 5) within communication device 30 is capable of detecting the received signal feedback. Data receiver/feedback unit 46A may record or store the received feedback, and/or one or more samples of the feedback, within data store 73. Data receiver/feedback unit 46A may compare at least a portion (e.g., one or more samples) of the received feedback, which may comprise a representation of the previously transmitted data, to at least a portion (e.g., one or more samples) of the transmitted data and determine whether to adjust a broadcast transmission parameter or a data transformation parameter for use in subsequent data communication based upon the comparison.

When collecting or extracting portions/samples of the received feedback that are to be compared the portions/samples of the transmitted data, data receiver/feedback unit 46A may interact with sampling unit 51. For instance, data receiver/feedback unit 46A may provide the received feedback to sampling unit 51, which may then sample the feedback and provide the samples to data receiver/feedback unit 46A for further processing. The size of the samples collected by sampling unit 51, along with the sampling frequency, may match the sample size(s) and sampling frequency(ies) for samples previously collected by sampling unit 51 from the source data that was previously transmitted by digital TV transformation unit/transmitter 42A.

In some examples, the received feedback may comprise rendered audio signals/feedback that is processed by data receiver/feedback unit 46A. This rendered audio may be provided, for example, by one or more speakers (speakers 22 of FIG. 3) of a data receiver. For example, data receiver/feedback unit 46A may compare the received audio signals to the audio contained in the data previously transmitted by digital TV transformation unit/transmitter 42A and determine if there is a certain amount of signal distortion, thereby allowing data receiver/feedback unit 46A to assess the quality of service delivered to any data receivers.

Data receiver/feedback unit 46A may determine whether any differences between at least a portion of the received representation of the data and at least a portion of the transmitted data exceed a defined threshold that may be indicative of a level of signal distortion. For example, in some cases, identifiable audio dropout or silence caused by missing audio data may be the source of a certain amount of signal distortion, particularly if the current transmit power setting is low or insufficient.

In certain instances, data receiver/feedback unit 46A may analyze at least the portion of the received representation of the data and at least the portion of the transmitted data to determine (e.g., measure, estimate) round-trip signal propagation delay, audio multipath characteristics, audio loudness, and/or room equalization characteristics. If the delay is long, if there are multiple paths, if the received data (e.g., audio data) is weak, or if the received data includes much frequency distortion, the further away a receiver may be located with respect to device 30, in which case transmit power could be increased to improve one or more of these characteristics. Some of these estimates or measurements could be enhanced if audio watermarks are used to serve as reference or timing sources. Audio watermarks are described in further detail below. Audio watermarks may be valuable in those scenarios in which the audio volume is low to begin with or there are longer silent periods.

In some cases, if the quality of the received audio feedback falls below a defined threshold (e.g., if there is too much signal distortion), as determined by data receiver/feedback unit 46A, power controller 57A may increase the transmit power for subsequent data that is transmitted by digital TV transformation unit/transmitter 42A, in an effort to reduce signal distortion of the subsequently transmitted data. In some cases, if data receiver/feedback unit 46A determines that the quality of the received audio signal feedback falls below a defined threshold, or continues to show a level of signal distortion, channel identifier 44A may identify another available channel for use by digital TV transformation unit/transmitter 42A for further subsequent data transmission.

In some examples, data receiver/feedback unit 46A may take into account any potential expected distortion for data that is, in general, received by communication device 30 when comparing the received audio feedback to the transmitted data and determining whether an additional, unexpected amount of signal distortion has occurred with respect to the received feedback. For instance, data receiver/feedback unit 46A data received previously by data receiver/feedback unit 46A to determine any amount of distortion that may be expected in subsequently received data (e.g., in the subsequently received feedback data), such as distortion that may be caused by room acoustics (e.g., background noise), by one or more speakers generating audio feedback, or even by one or more microphones that are used to sense or detect the received data.

For instance, prior to digital TV transformation unit/transmitter 42A sending any initial data, data receiver/feedback unit 46A may monitor, or detect, any room acoustic signals, such as background noise. Any such background noise may also potentially be expected to be present in subsequently received data. Upon transmission of data by digital TV transformation unit/transmitter 42A, data receiver/feedback unit 46A may detect the received (e.g., audio) feedback comprising a representation of at least a portion of the transmitted data, data receiver/feedback unit 46A may compare the received feedback to the transmitted data and determine whether the received feedback signals have an amount of distortion (e.g., due to transmission error) that exceeds the expected amount of distortion that may be caused by the previously detected background noise.

In other instances, when the received feedback processed by data receiver/feedback unit 46A includes representations of previously transmitted watermarks, data receiver/feedback unit 46A may analyze the received feedback data for the presence or absence of any such watermarks in the received data to help estimate the channel impulse response for the data communication channel that has been identified for use by channel identifier 44A. For instance, data receiver/feedback unit 46A may detect the absence of any watermarks in a portion of the received feedback data, and determine that this portion of received data may be associated with potential sources of expected noise/distortion (e.g., distortion that may be caused by room acoustics/background noise, by one or more speakers generating audio feedback, or even by one or more microphones that are used to sense or detect the received feedback data). In such fashion, data receiver/feedback unit 46A may be able to segregate amounts of expected noise/distortion in received feedback data from amounts of unexpected/abnormal distortion when determining the quality of the received data.

When assessing or determining any amounts of expected noise or distortion in received signals, data receiver/feedback unit 46A may dynamically adjust the value of any threshold parameter that is used when comparing the received signals to the transmitted data and determining whether any differences between the received signals and the transmitted data exceed the defined threshold value. For instance, if data receiver/feedback unit 46A detects an amount of background (or transient) noise, it may adjust (e.g., increase) the value of the defined threshold value. Over time, data receiver/feedback unit 46A may continually adjust the value of the defined threshold, as necessary, based upon changes in detected room acoustics (e.g., background noise).

FIG. 7 is a block diagram illustrating a sampling unit 51A, which is one example of sampling unit 51 shown in FIG. 6. Sampling unit 51A is communicatively coupled to data store 73. Sampling unit 51A also includes a sampling/insertion unit 80A and a sample access unit 82A.

Sampling unit 51A may be responsible for periodically sampling the data (e.g., multimedia data) that is to be transmitted by transmitter 59A (FIG. 6), and storing these samples within data store 73. Sample access unit 82A may manage the interface to data store 73, such that sampling/insertion unit 80A may store samples within data store 73. Sampling/insertion unit 80A may determine how much data is to be included in each sample, as well as how often to perform sampling of the transmit data stream(s). Over time, sample access unit 82A may determine how long to store samples within data store 73, and may delete old samples from data store 73 that may no longer be needed by communication device 30.

In some examples, sampling/insertion unit 80A may insert one or more watermarks into the data to be transmitted, which may then potentially be detected in the received signal data processed by data receiver/feedback unit 46A. Sampling/insertion unit 80A may determine how often to insert these watermarks into the data. In some instances, sampling/insertion unit 80A may retrieve the content of the watermark data that is to be inserted into the data from data store 73. In these instances, the watermark data may be pre-defined or pre-configured data. In other instances, sampling/insertion unit 80A may dynamically create or compute the watermark data that is to be inserted.

For instance, sampling/insertion unit 80A may compute one or more pseudo-noise sequences (e.g., spread-spectrum sequences) that are dynamically inserted into the transmission data. These sequences may comprise arbitrary or random sequences of bits. In some examples, the watermarks may comprise audio watermarks that are inserted into audio data within the data to be transmitted. The audio watermarks may, in various cases, comprise inaudible audio, such that when these watermarks are rendered and output (e.g., by one or more speakers), they are imperceptible by the human ear. Sample access unit 82A may store the watermarks as part of the samples that are stored in data store 73. Sample access unit 82A may store these watermarks in addition to, or in lieu of, the samples of the actual transmission data within data store 73.

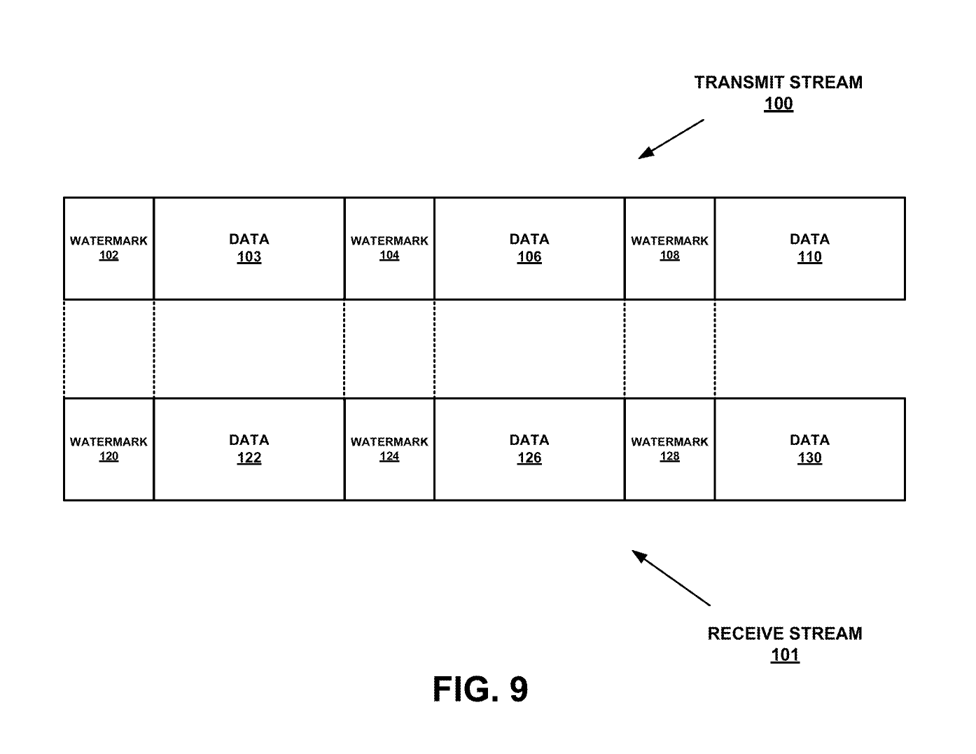

In one example, sample access unit 82A may only store the watermark data within data store 73. These watermarks may serve as the baseline samples against which the samples of the subsequent received feedback data may be compared in order to assess the quality/fidelity of the transmitted data. In other instances, such as in the example shown in FIG. 9, sample access unit 82A may store both the watermark data and additional samples of the source transmission data, collected by sampling/insertion unit 80A, within data store 73. In these instances, data receiver/feedback unit 46A may locate the watermarks within the received feedback data in order to determine the one or more portions of the received feedback data (e.g., which one or more samples of the feedback data) that are to be compared to the stored samples of the source transmission data, as will be described in more detail with reference to FIG. 9.

In one example, sample access unit 82A may store only samples of the source transmission data, collected by sampling/insertion unit 80A. In this example, sampling/insertion unit 80A may not insert any watermark data into the data stream(s), and no watermark data may be stored within data store 73.

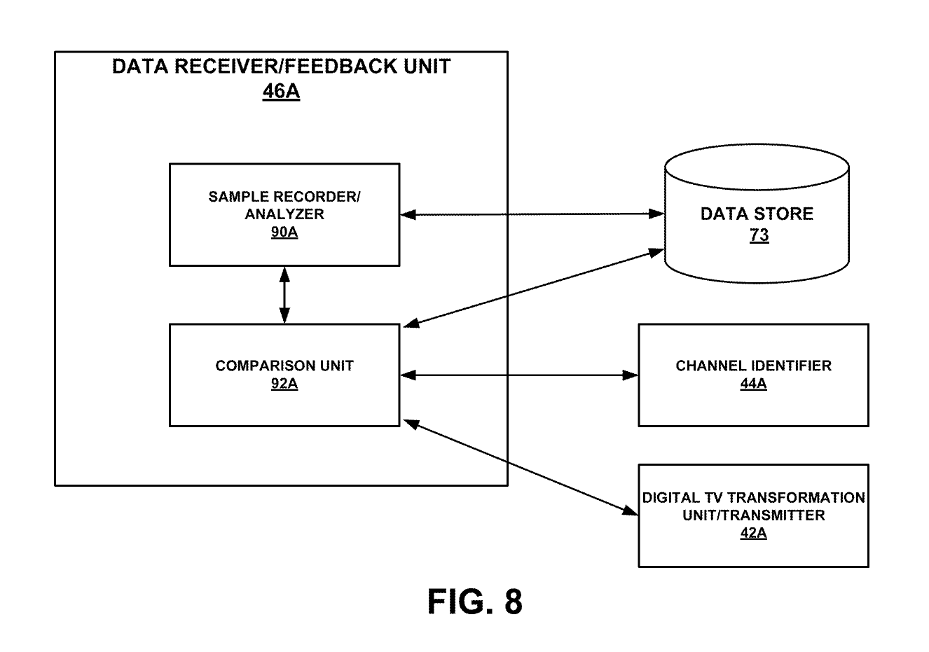

FIG. 8 is a block diagram illustrating one example of data receiver/feedback unit 46A shown in FIG. 6. Data receiver/feedback unit 46A allows communication device 30 to receive feedback (e.g., audio signal feedback) from a data receiver that has received and processed the data transmitted from digital TV transformation unit/transmitter 42A, which may then allow communication device 30 to identify the quality/fidelity of data transmission that is provided to this data receiver across the identified channel. As shown in FIG. 8, data receiver/feedback unit 46A may include a sample recorder/analyzer 90A and a comparison unit 92A.

In one example, data receiver/feedback unit 46A may receive a representation of the data (e.g., audio signal feedback) that was previously transmitted across an identified channel by digital TV transformation unit/transmitter 42A. A microphone (e.g., microphone 49 of FIG. 5) within communication device 30 is capable of detecting the received signal feedback. Sample recorder/analyzer may record or store the received feedback, and/or one or more samples of the feedback, within data store 73. Comparison unit 92A may compare at least a portion (e.g., one or more samples) of the received feedback, which may comprise a representation of the previously transmitted data, to at least a portion (e.g., one or more samples) of the transmitted data and determine whether to adjust a broadcast transmission parameter or a data transformation parameter for use in subsequent data communication based upon the comparison.

In one example, when the received feedback data processed by sample recorder/analyzer 90A includes watermarks, sample recorder/analyzer 90A may sample or extract these watermarks from the received data stream(s). Comparison unit 92A may then compare these extracted watermarks to the source watermarks stored in data store 73. The source watermarks were those previously sampled from the data transmission stream(s) sent by digital TV transformation unit/transmitter 42A. The extracted watermarks from the received feedback data may comprise a received representation of the source watermarks, based upon the rendering of the data transmission streams by a data receiver. The source watermarks may serve as baseline samples against which the samples of the subsequently extracted watermarks, from the received feedback data, may be compared in order to assess the quality/fidelity of the transmitted data.

As described above, in some instances, such as in the example shown in FIG. 9, sampling unit 51 may store both watermark data and additional samples of the source transmission data within data store 73. In these instances, sample recorder/analyzer 90A may locate the watermarks within the received feedback data in order to determine the one or more portions of the received feedback data (e.g., which one or more samples of the feedback data) are to be compared to the stored samples of the source transmission data by comparison unit 92A, as will be described in more detail with reference to FIG. 9.

In one example, sampling unit 51 may have only previously stored samples of the source transmission data. In this example, sampling unit 51 may not have inserted any watermark data into the source/transmission data stream(s), and no watermark data may have been stored within data store 73. In this example, sample recorder/analyzer 90A may extract samples of the received feedback signal data, and comparison unit 92A may then directly compare these extracted samples to the samples previously collected and stored within data store 73 by sampling unit 51 in order to assess the quality/fidelity of the transmitted data.

In some cases, if the quality of the received feedback falls below a defined threshold (e.g., if there is too much signal distortion), as determined by comparison unit 92A, digital TV transformation unit/transmitter 42A may increase the transmit power for subsequent data that is transmitted, in an effort to reduce signal distortion of the subsequently transmitted data. In some cases, if comparison unit 92A determines that the quality of the received signal feedback falls below a defined threshold, or continues to show a level of signal distortion, channel identifier 44A may identify another available channel for use by digital TV transformation unit/transmitter 42A for further subsequent data transmission.

FIG. 9 is a conceptual diagram illustrating an example of a transmit data stream 100 and a receive data stream 101 that each include watermark information. Any of the communication systems/devices shown in FIGS. 1-5 may be capable of processing transmit data stream 100 and receive data stream 101 shown in FIG. 9. For purposes of illustration only, however, it will be assumed that communication device 30 of FIG. 5 processes these streams 100, 101.

Transmit data stream 100 may be transmitted by digital TV transformation unit/transmitter 42 (e.g., via broadcast over an identified channel to one or more data receivers). In the particular example of FIG. 9, transmit stream 100 includes watermarks 102, 104, and 108 that have been inserted into transmit stream 100, interspersed between data 103, 106, and 110 in transmit stream 100. Sampling unit 51 (FIG. 6), for example, may insert watermarks 102, 104, and 108 into transmit stream 100, either before or after data 103, 106, and 110 has been encoded. Sampling unit 51 may store one or more of these watermarks 102, 104, 108 as samples within data store 73 (FIG. 6). In addition, in some cases, sampling unit 51 may sample one or more portions of data 103, 106, and 110 as samples within data store 73. Each of one or more of watermarks 102, 104, 108 may comprise a bitstream or code that is inserted into the data to be transmitted. In some cases, bits of a given watermark may be interleaved across data bits in the data 103, 106, 110 that is to be transmitted.

In some cases, watermarks 102, 104, and 108 may comprise audio watermarks, which may include audio data that, when decoded/rendered, may be inaudible to the human ear. In some cases, watermarks 102, 104, and 108 may comprise pseudo-noise, spread-spectrum sequences, which may include arbitrary or random sequences of bits. If the information included within transmit stream 100 has not yet been encoded by digital TV transformation unit/transmitter 42, TV transformation unit/transmitter 42 may encode the information of transmit stream 100, including watermarks 102, 104, and 108, and transmit the encoded data to a data receiver.

The data receiver (e.g., digital TV 27 shown in FIG. 3) may decode and render the information included within transmit stream 100, including watermarks 102, 104, 108 and data 103, 106, 110. In the example of FIG. 3, rendered video/image data may be displayed on display device 31, and rendered audio data may be provided as output from speakers 22.

Any rendered output data (e.g., rendered audio signal data) that is provided as output from a data receiver (e.g., speakers 22 of digital TV 27 in FIG. 3) may be received and processed as feedback by a data receiver/feedback unit, such as data receiver/feedback unit 35 of FIG. 3 or data receiver/feedback unit 46 of FIG. 5. Assuming, for purposes of illustration only, that data receiver/feedback unit 46 processes the received data, data receiver/feedback unit 46 may process the receive data stream 101 shown in FIG. 9, which may comprise a representation of the original stream 100 that was transmitted by communication device 30 and decoded/rendered by the data receiver.

Receive stream 101 may include rendered watermarks 120, 124, and 128 and data 122, 126, and 130. Watermarks 120, 124, and 128 may comprise representations of respective watermarks 102, 104, and 108 originally transmitted to the data receiver in transmit stream 100. Data 122, 126, and 130 in receive stream 101 may comprise representations of respective data 103, 106, and 110 from transmit stream 100. In cases where watermarks 120, 124, 128 may be interleaved across data bits in data 122, 126, 130, data receiver/feedback 46 may utilize a filtering mechanism to extract the watermark data.

In one example, data receiver/feedback unit 46 may compare watermarks 120, 124, and 128 to corresponding watermarks 102, 104, and 108 to determine whether there is any defined amount of distortion in receive stream 101 in comparison to transmit stream 100. For example, data receiver/feedback unit 46 may compare watermark 120 to watermark 102 and determine the strength/integrity of watermark 120 in receive stream 101. Based upon the comparison, data receiver/feedback unit 46 may determine whether there is a defined amount of distortion in watermark 120 with respect to watermark 102. Similarly, data receiver/feedback unit 46 may compare the strength/integrity of watermark 124 with respect to corresponding watermark 104 in transmit stream 100, and compare the strength/integrity of watermark 128 with respect to corresponding watermark 108 in transmit stream 100.

Data receiver/feedback unit 46 may determine whether to adjust a transmit power used for subsequent data transmission based upon whether any differences between one or more of watermarks 120, 124, and/or 128 and corresponding watermarks 102, 104, and/or 108 contained in transmit stream 100 exceed a defined threshold, which may be indicative of signal distortion within receive stream 101 that was processed by the data receiver.

As shown in FIG. 9, data receiver/feedback unit 46 may correlate information contained in transmit stream 100 with information contained in receive stream 101, and may align the two streams for comparison purposes in view of any signal propagation delay between when transmit stream 100 was sent from digital TV transformation unit/transmitter 42 and when receive stream 101 was received by data receiver/feedback unit 46. Data receiver/feedback unit 46 may utilize the watermarks in transmit stream 100 and receive stream 101 to assist in performing the alignment and/or correlation functions. As shown in FIG. 9, data receiver/feedback unit 46 may align the watermarks and data of transmit stream 100 and receive stream 101 such that comparison or cross-correlation functions may be performed. Watermark 102 is aligned with watermark 120, which is a representation in receive stream 101 of watermark 102. Data 103 of transmit stream 100 is aligned with data 122, which is a representation in receive stream 101 of data 103. Similarly, watermark 104 of transmit stream 100 is aligned with watermark 124 of receive stream 101, data 106 is aligned with data 126, watermark 108 is aligned with watermark 128, and data 110 is aligned with data 130.

In some examples, rather than analyzing only the watermarks in transmit and receive streams 100 and 101 for assessing possible signal distortion, data receiver/feedback unit 46 may also compare one or more portions/samples of data 122, 126, and/or 130 in receive stream 101 to corresponding portions/samples of data 103, 106, and/or 110 in transmit stream. In these examples, data receiver/feedback unit 46 and/or sampling unit 51 may extract one or more portions/samples of data 122, 126, and 130. The size of these samples, along with the sampling frequency, may match the sample size(s) and sampling frequency(ies) for samples collected by sampling unit 51 from transmit stream 100.

Data receiver/feedback unit 46 and/or sampling unit 51 may use the watermarks in transmit stream 100 and receive stream 101 as alignment indicators that allow proper sampling of data 122, 126, and 130. For instance, as shown in FIG. 9, identifying the locations of watermarks 120, 124, and 128 in receive stream 101 allows data receiver/feedback unit 46 and/or sampling unit 51 to align watermarks 120, 124, and 128 with corresponding watermarks 102, 104, and 108 in transmit stream 100. This may allow data receiver/feedback unit 46 and/or sampling unit 51 to determine the portions of data (e.g., data 122, 126, 130) in receive stream 101 that are to be compared the portions of data (e.g., data 103, 106, 110) in transmit stream 100. Data receiver/feedback unit 46 and/or sampling unit 51 may then sample data 122, 126, and/or 130 and compare these samples to the previously collected and stored samples of corresponding data 103, 106, and 110. Data receiver/feedback unit 46 may then determine whether any differences between these different samples exceed a defined threshold, which may be indicative of signal distortion.

In these examples, the watermarks in transmit stream 100 and receive stream 101 may be used only for purposes of aligning the remaining data within the streams for comparison purposes. In other examples, data receiver/feedback unit 46 may compare the watermarks and additional samples of data 122, 126, and/or 130 in receive stream 101 to the corresponding watermarks and samples of data 103, 106, and/or 110 in transmit stream 100 when identifying potential signal distortion within receive stream 101.

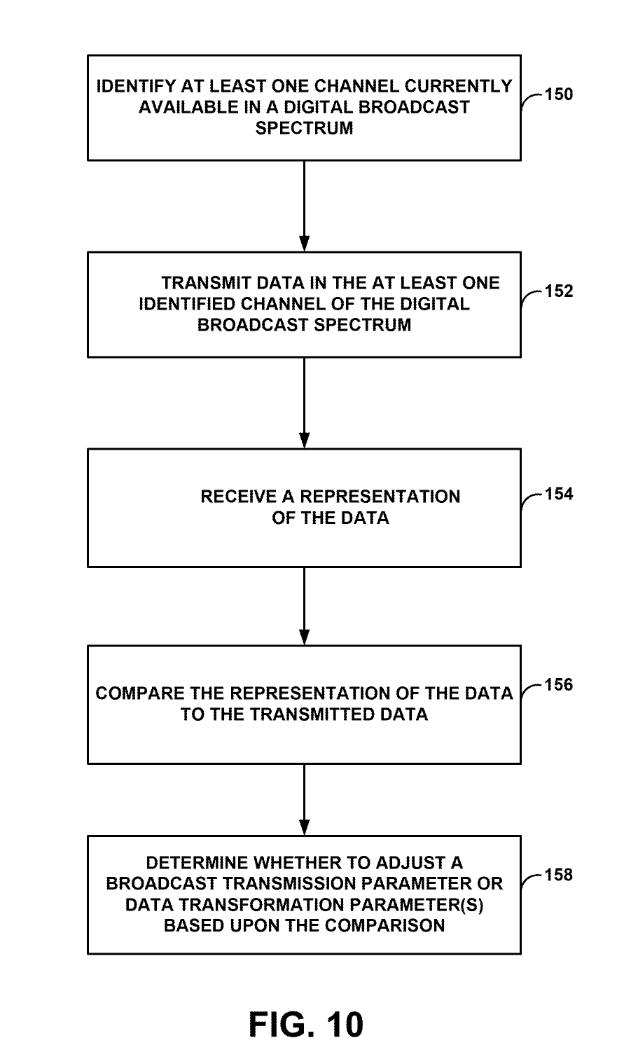

FIG. 10 is a flow diagram illustrating an example of a method that may be performed by a communication system or device, such as the communication system of FIG. 1 or one of the communication devices shown in FIGS. 2-5. For purposes of illustration only in the description below of FIG. 10, it will be assumed that the method may be performed by communication device 30 shown in FIG. 5.

Communication device 30 may use channel identifier 44 to identify at least one channel currently available in a digital broadcast spectrum (150). Digital TV transformation unit/transmitter 42 may transmit data via the at least one identified channel of the digital broadcast spectrum, where the transmitted data complies with a digital broadcast format (152). Data receiver/feedback unit 46 may receive a representation of the data (154), compare at least a portion (e.g., one or more samples) of the received representation of the data to at least a portion (e.g., one or more samples) of the transmitted data (156), and determine whether to adjust a broadcast transmission parameter or at least one data transformation parameter for use in subsequent data communication based upon the comparison (158). Digital TV transformation unit/transmitter 42 may transform the data, in some instances, into the digital broadcast format, and modulate the transformed data prior to its transmission. In these instances, communication device 30 may determine whether to adjust a data transformation parameter at least by determining whether to adjust a coding parameter for use in subsequent data transformation operations. For instance, communication device 30 may adjust a level, amount, type, or other coding parameter in an effort to reduce or eliminate signal distortion in subsequent data communications sent from device 30.

Communication device 30 may comprise a multimedia communication device having multimedia capabilities, and the data may comprise multimedia data including at least one of audio data, video data, text data, speech data, and graphics data. In some examples, the digital broadcast format may be an ATSC format, a T-DMB format, a DVB format, an ISDB-T format, or an MPEG-TS format (to name only a few examples), though various other digital formats may also be utilized. Device 30 may use one or more video and/or audio encoders (e.g., video/audio encoders 50A shown in FIG. 6) and/or multiplexers, along with one or more modulators/duplexers/switches, when transforming the multimedia data. Transforming the multimedia data may include encoding the multimedia data to comply with the digital broadcast format, and modulating the encoded multimedia data.

Channel identifier 44 of device 30 may identify at least one available channel of a spectrum. Such identification may, in some cases, be initiated by the device. For example, device 30 may use a spectrum sensor (e.g., spectrum sensor 70A of FIG. 6) and/or information accessed from a digital TV bands database (e.g., digital TV bands database 74 of FIG. 6) to identify the at least one available channel. In some cases, channel identifier 44 may identify the at least one available channel in an unused portion of a broadcast spectrum, such as a broadcast television spectrum. In some cases, the at least one available channel may comprise television band white space. The digital broadcast format may comprise an ATSC format, a T-DMB format, a DVB format, an ISDB-T format, or an MPEG-TS format, to name only a few non-limiting examples.

In one example, device 30 may include a geo-location sensor (e.g., geo-location sensor 73 of FIG. 6) to determine geographic coordinates of device 30. Device 30 may then provide the geographic coordinates as input to the digital TV bands database.

After device 30 has identified at least one available channel, device 30 may transmit (e.g., via transmitter 59A of FIG. 6) the transformed data (e.g., to one or more separate, external devices) in the at least one identified available channel. For example, device 30 may initiate a broadcast transmission to one or more external output devices, such as television devices, upon request of device 30.

Device 30 may transmit data using one or more first wireless communications, but may transmit the at least one command, which allows a second device to determine the identified available channel, using one or more second wireless communications. For instance, digital TV transformation unit/transmitter 42 may transmit data using an available channel, and a channel transmitter (e.g., channel transmitter 11 shown in FIG. 1, channel transmitter 13 shown in FIG. 2) may transmit command information via separate wireless communications to a channel receiver of a remote, receiving device. The command information may directly or indirectly identify the available channel. For example, the command information may directly specify the channel.

In some examples, data receiver/feedback unit 46 may determine whether to adjust a transmit power used for subsequent data transmission by digital TV transformation unit/transmitter 42. For example, data receiver/feedback unit 46 may determine whether any differences between at least the portion of the received representation of the data, detected by microphone 49, and at least the portion of the source data previously transmitted by digital TV transformation unit/transmitter 42 exceed a defined threshold indicative of signal distortion. The threshold may be defined by communication device 30, and may comprise a preconfigured threshold or a dynamically determined threshold.

If the threshold is preconfigured in communication device 30, it may be stored by communication device 30 in a data storage area (e.g., in memory 60 or data store 73 shown in FIG. 6). In some cases, data receiver/feedback unit 46 may dynamically compute or determine the threshold based upon one or more characteristics of the data previously transmitted by digital TV transformation unit/transmitter 42. For instance, the threshold may be at least partially based on the content of the data that has been transmitted.

If data receiver/feedback unit 46 determines that differences between at least the portion of the received representation of the data, detected by microphone 49, and at least the portion of the source data previously transmitted by digital TV transformation unit/transmitter 42 exceed a defined threshold, data receiver/feedback unit 46A may determine that such differences are indicative of signal distortion in the received representation of the data. For example, the signal distortion may at least in part be due to a defined number of data packets included in at least the portion of the transmitted data are not included in at least the portion of the received representation of the data (e.g., lost packets resulting in packet dropout).

In an effort to reduce or eliminate such distortion, data receiver/feedback unit 46 may cause digital TV transformation unit/transmitter 42 to transmit ensuing, additional data via the at least one identified channel with increased power when the differences exceed the defined threshold. For instance, power controller 57A (FIG. 6) may increase the transmit power when transmitter 59A sends further data across the transmission channel.

Upon transmission of this additional data with increased transmit power, data receiver/feedback unit 46 may then subsequently receive a representation of the additional data, which may be provided by a receiver (e.g., one of data receivers 9 in FIG. 1, one of data receivers 12A-12N of FIG. 2, digital TV 27 of FIG. 3) that received the transmitted, additional data. Data receiver/feedback unit 46 may compare at least a portion of the representation of the additional data to at least a portion of the transmitted additional data and determine whether any differences between the received representation of the additional data and the transmitted additional data continue to exceed the defined threshold. If so, power controller 57A (FIG. 6) may continue with one or more iterations of increasing transmit power for ensuing data communications in an effort to reduce signal distortion.

In some instances, however, communication device 30 may choose to use a different communication channel, in an effort to reduce signal distortion. For instance, if power controller 57A has increased a transmit power for data communication across an identified channel one or more times, but data receiver/feedback unit 46 detects continued signal distortion, it may be the case that there are issues of interference from one or more other devices on the currently identified channel. As a result, channel identifier 44 may identify at least one other channel currently available in the digital broadcast spectrum. Digital TV transformation unit/transmitter 42 may subsequently transmit further data in this at least one other identified channel.

As previously described with reference to FIGS. 6-9, digital TV transformation unit/transmitter 42 may, in various examples, inserting watermark information into the transmitted data. For instance, digital TV transformation unit/transmitter 42 may insert a plurality of audio watermarks into the data prior to transmission. In some cases, the audio watermarks may each comprise pseudo-noise, spread-spectrum sequences. In some cases, the audio watermarks may each comprise inaudible audio.

Data receiver/feedback unit 46 may receive representations of the audio watermarks contained in received audio signal feedback. Data receiver/feedback unit 46 may compare the received representations of the audio watermarks to the audio watermarks contained in the transmitted data. Data receiver/feedback unit 46 may determine whether to cause power controller 57A to adjust a transmit power used for subsequent data transmission based upon whether any differences between the received representations of the audio watermarks to the audio watermarks contained in the transmitted data exceed a defined threshold, which may be indicative of signal distortion with respect to one or more of the watermarks.

In some examples, data receiver/feedback unit 46A may compare the received representations of the audio watermarks to the audio watermarks contained in the transmitted data at least by identifying locations of the representations of the audio watermarks within the received representation of the data. Data receiver/feedback unit 46 may determine at least the portion of the received representation of the data that is to be compared to at least the portion of the transmitted data based upon the identified locations, as previously described with reference to FIG. 9.

In some examples, data receiver/feedback unit 46 may estimate an expected amount of signal distortion in the received representation of the data, such as by estimating any amounts of background noise (as previously described). Data receiver/feedback unit 46 may then account for the expected amount of signal distortion in the received representation of the data when determining whether there is any unexpected, or abnormal, amount of distortion in the received data.

In some examples, comparing at least the portion of the received representation of the data to at least the portion of the transmitted data may include comparing at least the portion of the received representation of the data to at least the portion of the transmitted data to estimate at least one of a signal round-trip propagation delay, one or more multipath characteristics, a loudness value, and one or more room equalization characteristics. The results of this comparison may then be used to determine whether to adjust a broadcast transmission parameter (e.g., transmit power) or a data transformation parameter for use in subsequent data communication.

The transmitted data may part of at least one multimedia data stream. For example, the transmitted data may comprise audio data that is part of one or more multimedia data streams of audio and/or video data. The representation of the data may include a representation of only a subset of data included within the at least one multimedia data stream (e.g., may include only audio data, or samples of audio data).

FIG. 11 is a flow diagram illustrating an example of another method that may be performed by a device, such as a device included within the system of FIG. 1 or one of the communication devices shown in FIGS. 2-5. For purposes of illustration only in the description below of FIG. 11, it will be assumed that the method may be performed by communication device 30 shown in FIG. 5.

Digital TV transformation unit/transmitter 42 may send multimedia data, including audio data, to a data receiver over an available transmission channel identified by channel identifier 44 (160). Sampling unit 51 (FIG. 6) may sample and store one or more portions (e.g., samples) of the audio data contained within the transmission data. In some cases, as described above, sampling unit 51 may insert one or more audio watermarks (e.g., pseudo-noise spread-spectrum sequences) into the transmission data, either before or after the data has been encoded by digital TV transformation unit/transmitter 42.

Data receiver/feedback unit 46 may then receive audio feedback (162). This audio feedback may be detected by microphone 49 from received audio signals generated by one or more speakers coupled to the data receiving device (e.g., speakers 22 of FIG. 3, speakers 98 of FIG. 4). Data receiver/feedback unit 46 may then determine whether there is a certain amount of signal distortion of the transmitted data based upon the received audio feedback (164).

For example, data receiver/feedback unit 46 may compare one or more samples of audio data contained in the originally transmission data with one or more samples of the audio feedback received by data receiver/feedback unit 46. In some cases, data receiver/feedback unit 46 may compare one or more audio watermarks that were originally inserted into the transmission data with one or more sampled audio watermarks contained in the received audio feedback. Based upon one or more of such comparisons, data receiver/feedback unit 46 may determine whether any differences exceed one or more defined (e.g., predetermined or calculated) thresholds, which may be indicative of sufficient and/or unacceptable signal distortion. If data receiver/feedback unit 46 does not detect such distortion, digital TV transformation unit/transmitter 42 may continue to send additional multimedia data to the data receiver (160).

If, however, data receiver/feedback unit 46 does detect sufficient distortion, digital TV transformation unit/transmitter 42 (e.g., power controller 57A shown in FIG. 6) may increase the transmit power for subsequent data that is transmitted to the data receiver (166). Subsequently, data receiver/feedback unit 46 may receive further audio feedback based upon the audio data included in the data stream(s) that were transmitted by digital TV transformation unit/transmitter 42 with increased power (168).

Upon receipt of the further audio feedback, data receiver/feedback unit 46 may determine whether there is continued signal distortion, or whether the distortion has been mitigated or eliminated due the increased transmit power of the data communication (170). If the distortion has been mitigated or eliminated (NO branch of 170), communication device 30 may continue sending the multimedia data (160) with the increased transmit power. However, if data receiver/feedback unit 46 detects continued signal distortion (YES branch of 170), channel identifier 44 may identify a different transmission channel (172) for further data communication. Digital TV transformation unit/transmitter 42 may then proceed with sending additional multimedia data over the newly identified channel in an effort to improve signal quality/fidelity. In some example scenarios, communication device 30 may repeat 166, 168, 170 over multiple iterations prior to channel identifier 44 identifying a different transmission channel at 172. In these example scenarios, communication device 30 may attempt to incrementally increase transmit power in an effort to eliminate or reduce signal distortion before determining to change the transmission channel.

In some examples, data receiver/feedback unit 46 may interact with digital TV transformation unit/transmitter 42 to iteratively increase the transmit power over multiple cycles, in small increments, prior to selecting a different transmission channel. During each cycle, data receiver/feedback unit 46 may determine, based upon received audio feedback, whether there is continued signal distortion. Digital TV transformation unit/transmitter 42 may increase transmit power in small increments in an effort to improve signal fidelity (and reduce signal distortion in the received signal), while not necessarily overly amplifying the transmission data signal stream(s). If, however, the signal distortion persists after increasing the transmit power over these multiple cycles, channel identifier 44 may identify a new available channel for subsequent data transmission, given that the current channel may potentially have interference issues with other transmissions (e.g., transmissions from nearby sources).

The techniques described in this disclosure may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, firmware. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for ease of illustration, and does not necessarily require realization of such features by separate hardware, firmware, or software components. In some cases, various units may be implemented as programmable processes performed by one or more processors.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of image, display, audio, or other multi-multimedia applications and devices. In some aspects, for example, such components may form part of a mobile device, such as a wireless communication device handset (e.g., a mobile telephone handset).

If implemented in software, the techniques may be realized at least in part by a computer-readable data storage medium comprising code with instructions that, when executed by one or more processors, performs one or more of the methods described above. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

Various aspects have been described in this disclosure. These and other aspects are within the scope of the following claims.

1. A method comprising:
identifying at least one channel currently available in a digital broadcast spectrum;
transmitting data via the at least one identified channel of the digital broadcast spectrum, wherein the transmitted data complies with a digital broadcast format;
receiving a representation of the data;
comparing, by at least one device, at least a portion of the received representation of the data to at least a portion of the transmitted data; and
determining, by the at least one device, whether to adjust a broadcast transmission parameter or a data transformation parameter for use in subsequent data communication based upon the comparison.

2. The method of claim 1, further comprising:
transforming the data into the digital broadcast format; and
modulating the transformed data prior to its transmission.

3. The method of claim 2, wherein determining whether to adjust the broadcast transmission parameter or the data transformation parameter comprises determining whether to adjust a coding parameter for use in subsequent data transformation operations.

4. The method of claim 1, wherein:
identifying the at least one channel comprises identifying the at least one channel in an unused portion of a digital broadcast television spectrum; and
transmitting the data comprises transmitting the data according to the digital broadcast format via the at least one identified channel of the digital broadcast television spectrum.

5. The method of claim 1, wherein the digital broadcast format comprises an ATSC (Advanced Television Systems Committee) format, a T-DMB (Terrestrial Digital Multimedia Broadcasting) format, a DVB (Digital Video Broadcasting) format, an Integrated Services Digital Broadcasting Terrestrial (ISDB-T) format, or a Moving Picture Experts Group Transport Stream (MPEG-TS) format.

6. The method of claim 1, wherein identifying the at least one channel comprises identifying television band white space.

7. The method of claim 1, wherein the data comprises at least one of audio data, video data, text data, speech data, graphics data, and ancillary interactivity data.

8. The method of claim 1, wherein comparing at least the portion of the received representation of the data to at least the portion of the transmitted data comprises comparing one or more samples of the received representation of the data to corresponding one or more samples of the transmitted data.

9. The method of claim 1, wherein determining whether to adjust the broadcast transmission parameter or the data transformation parameter comprises determining whether to adjust a transmit power used for subsequent data transmission.

10. The method of claim 9, wherein determining whether to adjust the transmit power comprises determining whether any differences between at least the portion of the received representation of the data and at least the portion of the transmitted data exceed a defined threshold indicative of signal distortion, and wherein the method further comprises:
transmitting additional data via the at least one identified channel with increased power when the differences exceed the defined threshold.

11. The method of claim 10, further comprising:
receiving a representation of additional data;
comparing at least a portion of the representation of the additional data to at least a portion of the transmitted additional data;
responsive to determining that any differences between at least the portion of the received representation of the additional data and at least the portion of the transmitted additional data continue to exceed the defined threshold, identifying at least one other channel currently available in the digital broadcast spectrum; and
transmitting further data via the at least one other identified channel.

12. The method of claim 11, further comprising:
repeating the transmitting of additional data with increased power multiple iterations prior to transmitting further data via the at least one other identified channel.

13. The method of claim 10, wherein determining whether any differences between at least the portion of the received representation of the data and at least the portion of the transmitted data exceed the defined threshold comprise determining that a defined number of data packets included in at least the portion of the transmitted data are not included in at least the portion of the received representation of the data.

14. The method of claim 1, wherein:
transmitting the data comprises inserting a plurality of audio watermarks into the data prior to transmission;
receiving the representation of the data comprises receiving representations of the audio watermarks; and
comparing comprises comparing the received representations of the audio watermarks to the audio watermarks contained in the transmitted data.

15. The method of claim 14, wherein the audio watermarks comprises at least one of a pseudo-noise spread-spectrum sequence and inaudible audio.

16. The method of claim 14, wherein determining whether to adjust the broadcast transmission parameter or the data transformation parameter comprises determining whether to adjust a transmit power used for subsequent data transmission based upon whether any differences between the received representations of the audio watermarks to the audio watermarks contained in the transmitted data exceed a defined threshold.

17. The method of claim 14, wherein comparing the received representations of the audio watermarks to the audio watermarks contained in the transmitted data comprises:
identifying locations of the representations of the audio watermarks within the received representation of the data; and
determining at least the portion of the received representation of the data that is to be compared to at least the portion of the transmitted data based upon the identified locations.

18. The method of claim 1, further comprising:
estimating an expected amount of signal distortion in the received representation of the data, and wherein the comparing comprises accounting for the expected amount of signal distortion in the received representation of the data.

19. The method of claim 1, wherein comparing at least the portion of the received representation of the data to at least the portion of the transmitted data comprises comparing at least the portion of the received representation of the data to at least the portion of the transmitted data to estimate at least one of a signal round-trip propagation delay, one or more multipath characteristics, a loudness value, and one or more room equalization characteristics.

20. The method of claim 1, wherein the transmitted data is part of at least one multimedia data stream, and wherein the representation of the data includes a representation of only a subset of data included within the at least one multimedia data stream.

21. A communication system, comprising:
one or more processors;
a channel identifier operable by the one or more processors to identify at least one channel currently available in a digital broadcast spectrum;
a transmitter operable by the one or more processors to transmit data via the at least one identified channel of the digital broadcast spectrum, wherein the transmitted data complies with a digital broadcast format;
a data receiver/feedback unit operable by the one or more processors to receive a representation of the data and compare at least a portion of the received representation of the data to at least a portion of the transmitted data,
wherein the one or more processors are configured to determine whether to adjust a broadcast transmission parameter or a data transformation parameter for use in subsequent data communication based upon the comparison.

22. The communication system of claim 21, further comprising:
a transformation unit operable by the one or more processors to transform the data into the digital broadcast format; and
a modulator operable by the one or more processors to modulate the transformed data prior to its transmission.

23. The communication system of claim 22, wherein the one or more processors are configured to determine whether to adjust the broadcast transmission parameter or the data transformation parameter at least by determining whether to adjust a coding parameter for use in subsequent data transformation operations.

24. The communication system of claim 21, wherein:
the channel identifier is operable to identify the at least one channel in an unused portion of a digital broadcast television spectrum; and
the transmitter is operable to transmit the data according to the digital broadcast format via the at least one identified channel of the digital broadcast television spectrum.

25. The communication system of claim 21, wherein the digital broadcast format comprises an ATSC (Advanced Television Systems Committee) format, a T-DMB (Terrestrial Digital Multimedia Broadcasting) format, a DVB (Digital Video Broadcasting) format, an Integrated Services Digital Broadcasting Terrestrial (ISDB-T) format, or a Moving Picture Experts Group Transport Stream (MPEG-TS) format.

26. The communication system of claim 21, wherein the channel identifier is operable to identify the at least one channel at least by identifying television band white space.

27. The communication system of claim 21, wherein the data comprises at least one of audio data, video data, text data, speech data, graphics data, and ancillary interactivity data.

28. The communication system of claim 21, wherein the data receiver/feedback unit is operable to compare at least the portion of the received representation of the data to at least the portion of the transmitted data at least by comparing one or more samples of the received representation of the data to corresponding one or more samples of the transmitted data.

29. The communication system of claim 21, wherein the one or more processors are operable to determine whether to adjust the broadcast transmission parameter or the data transformation parameter at least by determining whether to adjust a transmit power used for subsequent data transmission.

30. The communication system of claim 29, wherein the one or more processors are configured to determine whether to adjust the transmit power at least by determining whether any differences between at least the portion of the received representation of the data and at least the portion of the transmitted data exceed a defined threshold indicative of signal distortion, and wherein the transmitter is further operable to transmit additional data via the at least one identified channel with increased power when the differences exceed the defined threshold.

31. The communication system of claim 30, wherein:
the data receiver/feedback unit is further operable to receive a representation of additional data and compare at least a portion of the representation of the additional data to at least a portion of the transmitted additional data;
responsive to determining that any differences between at least the portion of the received representation of the additional data and at least the portion of the transmitted additional data continue to exceed the defined threshold, the channel identifier is further operable to identify at least one other channel currently available in the digital broadcast spectrum; and
the transmitter is further operable to transmit further data via the at least one other identified channel.

32. The communication system of claim 31, wherein the one or more processors are further configured to repeat the transmitting of additional data with increased power multiple iterations prior to transmitting further data via the at least one other identified channel.

33. The communication system of claim 30, wherein the one or more processors are configured to determine whether any differences between at least the portion of the received representation of the data and at least the portion of the transmitted data exceed the defined threshold at least by determining that a defined number of data packets included in at least the portion of the transmitted data are not included in at least the portion of the received representation of the data.

34. The communication system of claim 21, wherein:
the transmitter is operable to transmit the data at least by inserting a plurality of audio watermarks into the data prior to transmission;
the data receiver/feedback unit is operable to receive the representation of the data at least by receiving representations of the audio watermarks; and
the data receiver/feedback unit is operable to compare the received representations of the audio watermarks to the audio watermarks contained in the transmitted data.

35. The communication system of claim 34, wherein the audio watermarks comprises at least one of a pseudo-noise spread-spectrum sequence and inaudible audio.

36. The communication system of claim 34, wherein the one or more processors are configured to determine whether to adjust the broadcast transmission parameter or the data transformation parameter at least by determining whether to adjust a transmit power used for subsequent data transmission based upon whether any differences between the received representations of the audio watermarks to the audio watermarks contained in the transmitted data exceed a defined threshold.

37. The communication system of claim 34, wherein the data receiver/feedback unit is operable to compare the received representations of the audio watermarks to the audio watermarks contained in the transmitted data at least by identifying locations of the representations of the audio watermarks within the received representation of the data, and by determining at least the portion of the received representation of the data that is to be compared to at least the portion of the transmitted data based upon the identified locations.

38. The communication system of claim 21, wherein the one or more processors are further configured to estimate an expected amount of signal distortion in the received representation of the data and to account for the expected amount of signal distortion in the received representation of the data.

39. The communication system of claim 21, wherein the data receiver/feedback unit is operable to compare at least the portion of the received representation of the data to at least the portion of the transmitted data at least by comparing at least the portion of the received representation of the data to at least the portion of the transmitted data to estimate at least one of a signal round-trip propagation delay, one or more multipath characteristics, a loudness value, and one or more room equalization characteristics.

40. The communication system of claim 21, wherein the transmitted data is part of at least one multimedia data stream, and wherein the representation of the data includes a representation of only a subset of data included within the at least one multimedia data stream.

41. The communication system of claim 21, wherein the communication system comprises a wireless communication device handset.

42. The communication system of claim 21, wherein the communication system comprises one or more integrated circuit devices.

43. A communication system, comprising:
means for identifying at least one channel currently available in a digital broadcast spectrum;
means for transmitting data via the at least one identified channel of the digital broadcast spectrum, wherein the transmitted data complies with a digital broadcast format;
means for receiving a representation of the data;
means for comparing at least a portion of the received representation of the data to at least a portion of the transmitted data; and
means for determining whether to adjust a broadcast transmission parameter or a data transformation parameter for use in subsequent data communication based upon the comparison.

44. The communication system of claim 43, further comprising:
means for transforming the data into the digital broadcast format; and
means for modulating the transformed data prior to its transmission.

45. The communication system of claim 44, wherein the means for determining whether to adjust the broadcast transmission parameter or the data transformation parameter comprises means for determining whether to adjust a coding parameter for use in subsequent data transformation operations.

46. The communication system of claim 43, wherein the means for comparing at least the portion of the received representation of the data to at least the portion of the transmitted data comprises means for comparing one or more samples of the received representation of the data to corresponding one or more samples of the transmitted data.

47. The communication system of claim 43, wherein the means for determining whether to adjust the broadcast transmission parameter or the data transformation parameter comprises means for determining whether to adjust a transmit power used for subsequent data transmission.

48. The communication system of claim 47, wherein the means for determining whether to adjust the transmit power comprises means for determining whether any differences between at least the portion of the received representation of the data and at least the portion of the transmitted data exceed a defined threshold indicative of signal distortion, and wherein the communication system further comprises:
means for transmitting additional data via the at least one identified channel with increased power when the differences exceed the defined threshold.

49. The communication system of claim 48, further comprising:
means for receiving a representation of additional data;
means for comparing at least a portion of the representation of the additional data to at least a portion of the transmitted additional data;
means for responsive to determining that any differences between at least the portion of the received representation of the additional data and at least the portion of the transmitted additional data continue to exceed the defined threshold, identifying at least one other channel currently available in the digital broadcast spectrum; and
means for transmitting further data via the at least one other identified channel.

50. The communication system of claim 43, wherein:
the means for transmitting the data comprises means for inserting a plurality of audio watermarks into the data prior to transmission;
the means for receiving the representation of the data comprises means for receiving representations of the audio watermarks; and
the means for comparing comprises means for comparing the received representations of the audio watermarks to the audio watermarks contained in the transmitted data.

51. The communication system of claim 50, wherein the audio watermarks comprises at least one of a pseudo-noise spread-spectrum sequence and inaudible audio.

52. The communication system of claim 50, wherein the means for determining whether to adjust the broadcast transmission parameter or the data transformation parameter comprises means for determining whether to adjust a transmit power used for subsequent data transmission based upon whether any differences between the received representations of the audio watermarks to the audio watermarks contained in the transmitted data exceed a defined threshold.

53. The communication system of claim 50, wherein the means for comparing the received representations of the audio watermarks to the audio watermarks contained in the transmitted data comprises:
means for identifying locations of the representations of the audio watermarks within the received representation of the data; and
means for determining at least the portion of the received representation of the data that is to be compared to at least the portion of the transmitted data based upon the identified locations.

54. The communication system of claim 43, further comprising:
means for estimating an expected amount of signal distortion in the received representation of the data, and wherein the comparing comprises accounting for the expected amount of signal distortion in the received representation of the data.

55. The communication system of claim 43, wherein the means for comparing at least the portion of the received representation of the data to at least the portion of the transmitted data comprises means for comparing at least the portion of the received representation of the data to at least the portion of the transmitted data to estimate at least one of a signal round-trip propagation delay, one or more multipath characteristics, a loudness value, and one or more room equalization characteristics.

56. A computer-readable storage medium encoded with instructions for causing one or more processors to:
identify at least one channel currently available in a digital broadcast spectrum;
transmit data via the at least one identified channel of the digital broadcast spectrum, wherein the transmitted data complies with a digital broadcast format;
receive a representation of the data;
compare at least a portion of the received representation of the data to at least a portion of the transmitted data; and
determine whether to adjust a broadcast transmission parameter or a data transformation parameter for use in subsequent data communication based upon the comparison.

57. The computer-readable storage medium of claim 56, further encoded with instructions to:
transform the data into the digital broadcast format; and
modulate the transformed data prior to its transmission.

58. The computer-readable storage medium of claim 57, wherein the instructions to determine whether to adjust the broadcast transmission parameter or the data transformation parameter comprise instructions to determine whether to adjust a coding parameter for use in subsequent data transformation operations.

59. The computer-readable storage medium of claim 56, wherein the instructions to compare at least the portion of the received representation of the data to at least the portion of the transmitted data comprise instructions to compare one or more samples of the received representation of the data to corresponding one or more samples of the transmitted data.

60. The computer-readable storage medium of claim 56, wherein the instructions to determine whether to adjust the broadcast transmission parameter or the data transformation parameter comprise instructions to determine whether to adjust a transmit power used for subsequent data transmission.

61. The computer-readable storage medium of claim 60, wherein the instructions to determine whether to adjust the transmit power comprise instructions to determine whether any differences between at least the portion of the received representation of the data and at least the portion of the transmitted data exceed a defined threshold indicative of signal distortion, and wherein the computer-readable storage medium is further encoded with instructions to:
transmit additional data via the at least one identified channel with increased power when the differences exceed the defined threshold.

62. The computer-readable storage medium of claim 61, further encoded with instructions to:
receive a representation of additional data;
compare at least a portion of the representation of the additional data to at least a portion of the transmitted additional data;
responsive to determining that any differences between at least the portion of the received representation of the additional data and at least the portion of the transmitted additional data continue to exceed the defined threshold, identify at least one other channel currently available in the digital broadcast spectrum; and
transmit further data via the at least one other identified channel.

63. The computer-readable storage medium of claim 56, wherein:
the instructions to transmit the data comprise instructions to insert a plurality of audio watermarks into the data prior to transmission;
the instructions to receive the representation of the data comprise instructions to receive representations of the audio watermarks; and
the instructions to compare comprise instructions to compare the received representations of the audio watermarks to the audio watermarks contained in the transmitted data.

64. The computer-readable storage medium of claim 63, wherein the audio watermarks comprises at least one of a pseudo-noise spread-spectrum sequence and inaudible audio.

65. The computer-readable storage medium of claim 63, wherein the instructions to determine whether to adjust the broadcast transmission parameter or the data transformation parameter comprise instructions to determine whether to adjust a transmit power used for subsequent data transmission based upon whether any differences between the received representations of the audio watermarks to the audio watermarks contained in the transmitted data exceed a defined threshold.

66. The computer-readable storage medium of claim 63, wherein the instructions to compare the received representations of the audio watermarks to the audio watermarks contained in the transmitted data comprise instructions to:
identify locations of the representations of the audio watermarks within the received representation of the data; and
determine at least the portion of the received representation of the data that is to be compared to at least the portion of the transmitted data based upon the identified locations.

67. The computer-readable storage medium of claim 56, further encoded with instructions to:
estimate an expected amount of signal distortion in the received representation of the data, and wherein the comparing comprises accounting for the expected amount of signal distortion in the received representation of the data.

68. The computer-readable storage medium of claim 56, wherein the instructions to compare at least the portion of the received representation of the data to at least the portion of the transmitted data comprise instructions to compare at least the portion of the received representation of the data to at least the portion of the transmitted data to estimate at least one of a signal round-trip propagation delay, one or more multipath characteristics, a loudness value, and one or more room equalization characteristics.
